(19) United States
(12) Patent Application Publication
(10) Pub. No.: US 2024/0349412 A1
(43) Pub. Date: Oct. 17, 2024

(54) DRIVE DEVICE, LIGHT EMITTING APPARATUS, AND DISTANCE MEASUREMENT APPARATUS

(71) Applicant: FUJIFILM Business Innovation Corp., Tokyo (JP)

(72) Inventors: Kei TAKEYAMA, Kanagawa (JP); Daisuke IGUCHI, Kanagawa (JP); Emiko SHIRAISHI, Tokyo (JP); Junichiro HAYAKAWA, Kanagawa (JP)

(73) Assignee: FUJIFILM Business Innovation Corp., Tokyo (JP)

(21) Appl. No.: 18/582,597

(22) Filed: Feb. 20, 2024

(30) Foreign Application Priority Data
Apr. 17, 2023 (JP) 2023-067230

(51) Int. Cl. H05B 47/16; G01S 7/484; G01S 17/10; G01S 17/89; H05B 47/155; H05B 47/165

(52) U.S. Cl. CPC H05B 47/16; G01S 7/484; G01S 17/10; G01S 17/89; H05B 47/155; H05B 47/165

(57) ABSTRACT

A drive device is configured to: cause a light emitting device including plural light emitting sections to emit light such that each of the light emitting sections has a predetermined plural light emitting periods and a light non-emitting period following each of the light emitting periods; and switch a second light emitting section other than a first light emitting section among the plural light emitting sections, which has a light emitting period to be included in a light non-emitting period of the first light emitting section.

### CROSS-REFERENCE TO RELATED APPLICATIONS

This application is based on and claims priority under 35 USC 119 from Japanese Patent Application No. 2023-067230 filed Apr. 17, 2023.

### BACKGROUND

### (i) Technical Field

The present invention relates to a drive device, a light emitting apparatus, and a distance measurement apparatus.

### (ii) Related Art

In JP2020-153796A, there is described a distance measurement apparatus that has a light projecting unit having a plurality of light emitting units, and acquires distance data to a target object based on light that is projected from the light emitting unit and reflected by the target object. In this distance measurement apparatus, the plurality of light emitting units are divided into a plurality of groups, and the light emitting units that emit light are switched for each group in time series.

### SUMMARY

In the distance measurement apparatus or the like having the light emitting unit including a plurality of light emitting sections, in some cases, each light emitting section is provided to emit light by having a plurality of light emitting periods and a light non-emitting period following each light emitting period, and the distance is measured. In such a distance measurement apparatus or the like, in a case where another light emitting section emits light during a light non-emitting period of one light emitting section among the plurality of light emitting sections and in a case where the other light emitting section that emits the light during the light non-emitting period of the one light emitting section is uniformly handled, it may be difficult to emit light that is appropriate for situations such as a target object to be irradiated with the light by the light emitting section and heat generation of the light emitting section.

Aspects of non-limiting embodiments of the present disclosure relate to a drive device, a light emitting apparatus, and a distance measurement apparatus that emit light appropriate for a situation, as compared with a case where another light emitting section that emits light during a light non-emitting period of one light emitting section among a plurality of light emitting sections is not switched.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a drive device configured to: cause a light emitting device including a plurality of light emitting sections to emit light such that each of the light emitting sections has a predetermined plurality of light emitting periods and a light non-emitting period following each of the light emitting periods; and switch a second light emitting section other than a first light emitting section among the plurality of light emitting sections, which has a light emitting period to be included in a light non-emitting period of the first light emitting section.

### BRIEF DESCRIPTION OF THE DRAWINGS

Exemplary embodiment(s) of the present invention will be described in detail based on the following figures, wherein:

FIG. 1 is a block diagram illustrating an example of a schematic configuration of a distance measurement apparatus according to the present exemplary embodiment;

FIG. 2 is a diagram illustrating a relationship between a light emitting surface of a light emitting unit according to the present exemplary embodiment and an irradiation surface irradiated with light emitted from the light emitting unit;

FIG. 3 is a diagram illustrating an example of the light emitting unit according to the present exemplary embodiment;

FIG. 4 is a diagram illustrating a relationship between a light receiving surface of a light receiving unit according to the present exemplary embodiment and the irradiation surface described above;

FIGS. 5A to 5C are diagrams describing a distance image according to the present exemplary embodiment, FIG. 5A is a diagram illustrating a positional relationship between a distance measurement apparatus and a target object, FIG. 5B is a diagram illustrating a state of the irradiation surface, and FIG. 5C is a diagram illustrating an example of the distance image created by a control unit;

FIG. 6 is a diagram illustrating a first operation pattern of the distance measurement apparatus to which the present exemplary embodiment is applied;

FIG. 7 is a diagram illustrating a second operation pattern of the distance measurement apparatus to which the present exemplary embodiment is applied;

FIG. 8 is a diagram illustrating a third operation pattern of the distance measurement apparatus to which the present exemplary embodiment is applied;

FIG. 9 is a diagram illustrating a fourth operation pattern of the distance measurement apparatus to which the present exemplary embodiment is applied;

FIG. 10 is a diagram illustrating an example of a situation of a target object existing at the irradiation surface and a method of grouping irradiation sections in a fifth operation pattern;

FIG. 11 is a diagram illustrating the fifth operation pattern of the distance measurement apparatus to which the present exemplary embodiment is applied;

FIG. 12 is a diagram illustrating the situation of the target object existing at the irradiation surface and a method of grouping irradiation sections in a sixth operation pattern;

FIG. 13 is a diagram illustrating the sixth operation pattern of the distance measurement apparatus to which the present exemplary embodiment is applied;

FIG. 14 is a diagram illustrating the situation of the target object existing at the irradiation surface and a method of grouping irradiation sections in a seventh operation pattern;

FIG. 15 is a diagram illustrating the seventh operation pattern of the distance measurement apparatus to which the present exemplary embodiment is applied;

FIGS. 16A and 16B are diagrams illustrating an eighth operation pattern and a ninth operation pattern of the distance measurement apparatus to which the exemplary embodiment is applied; and

FIGS. 17A to 17C are diagrams illustrating an example of a light emitting operation in one light emitting period of each light emitting section.

### DETAILED DESCRIPTION

Hereinafter, exemplary embodiments of the present invention will be described in detail with reference to the accompanying drawings.

The technical scope of the present invention is not limited to the scope to be described below as an exemplary embodiment. It is clear from the description of the claims that a combination of a plurality of examples and various modifications or improvements to the exemplary embodiment described above are also included in the technical scope of the present invention.

### Distance Measurement Apparatus 1

### Overall Configuration

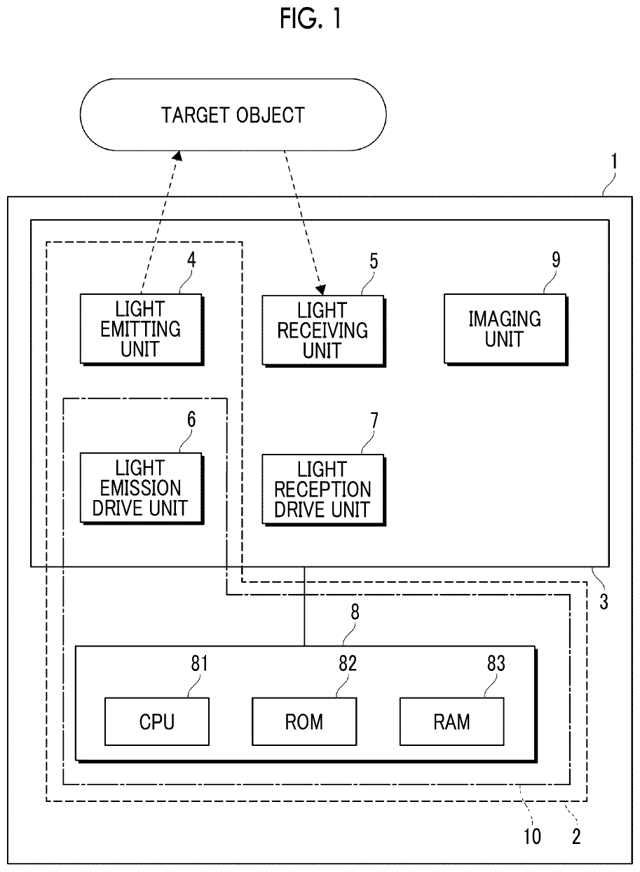

FIG. 1 is a block diagram illustrating an example of a schematic configuration of a distance measurement apparatus 1 according to the present exemplary embodiment.

The distance measurement apparatus 1 measures a distance to a target object based on a time from a timing at which light is emitted from a light emitting unit 4 to a timing at which the light reflected by the target object is received by the light receiving unit 5.

That is, the distance measurement apparatus 1 is a device that performs distance measurement based on a ToF method. The ToF method includes an indirect ToF (iToF) method in which a time is measured from a difference between a phase of emitted light and a phase of received light, and a direct ToF (dToF) method in which a time from emission to reception of light is directly measured. In the present exemplary embodiment, the distance measurement apparatus 1 is assumed to perform distance measurement based on the indirect ToF method.

As illustrated in FIG. 1, the distance measurement apparatus 1 includes an optical device 3 and a control unit 8.

The optical device 3 includes the light emitting unit 4 that emits light toward a predetermined irradiation range, a light receiving unit 5 that receives the light emitted from the light emitting unit 4 and reflected by a target object existing in the irradiation range, a light emission drive unit 6 that drives the light emitting unit 4, and a light reception drive unit 7 that drives the light receiving unit 5. Further, the optical device 3 includes an imaging unit 9 that images the irradiation range and acquires an infrared image of the irradiation range. This infrared image is an example of an image captured by the imaging unit 9.

Details of the configurations of the light emitting unit 4 and the light receiving unit 5 of the optical device 3 will be described below. In addition, reference numeral 2 indicated by a broken line and reference numeral 10 indicated by a one-dot chain line will be described below.

The control unit 8 controls the operations of the light emitting unit 4 and the light receiving unit 5 of the optical device 3.

In addition, the control unit 8 acquires a result of the light reception by the light receiving unit 5, and measures a distance from the distance measurement apparatus 1 to the target object by the ToF method based on the result of the light reception.

The control unit 8 is an example of a control unit.

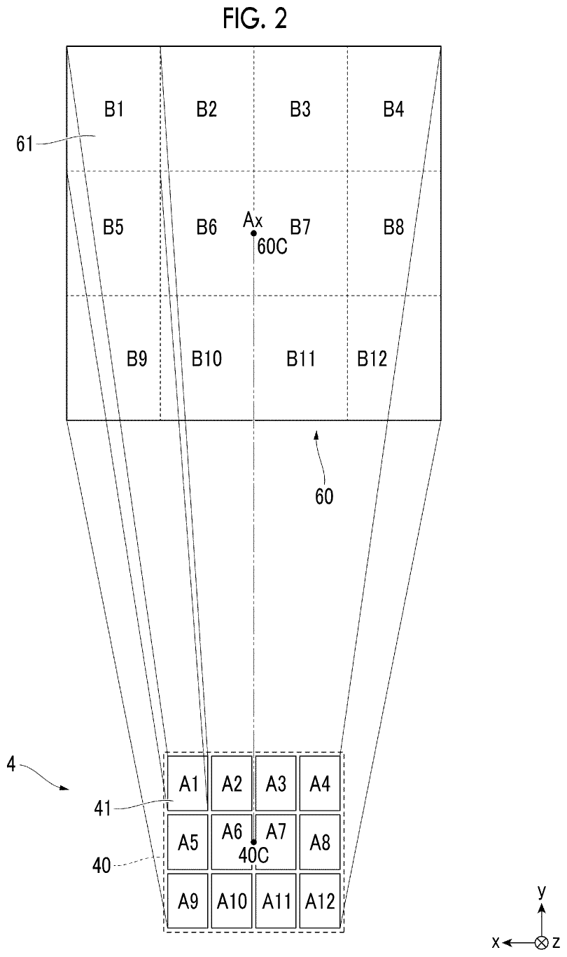

The imaging unit 9 detects infrared rays radiated from the target object existing in the irradiation range (irradiation surface 60 in FIG. 2 to be described below), and outputs an infrared image generated from the detection result to the control unit 8. The imaging unit 9 continuously or intermittently detects the infrared rays in the irradiation range at predetermined time intervals to generate an infrared image.

The control unit 8 ascertains a situation of the target object in the irradiation range by analyzing the infrared image acquired from the imaging unit 9. The control unit 8 ascertains whether the target object is a moving object moving in the irradiation range or a stationary object, as the situation of the target object in the irradiation range. In addition, the control unit 8 ascertains which irradiation section 61 (see FIG. 2 to be described below) the target object exists in the irradiation range, as the situation of the target object in the irradiation range. Further, the control unit 8 ascertains a movement direction of the target object in the irradiation range and the relative movement amount of the target object in the irradiation range in a case where the target object is a moving object, as the situation of the target object in the irradiation range.

### Light Emitting Unit 4

FIG. 2 is a diagram illustrating a relationship between a light emitting surface 40 of the light emitting unit 4 according to the present exemplary embodiment and an irradiation surface 60 irradiated with light emitted from the light emitting unit 4. A left direction of the page plane of FIG. 2 is a +x direction, an upward direction of the page plane of FIG. 2 is a ty direction, a back side direction of the page plane of FIG. 2 is a +z direction, and each opposite directions are −x, −y, and −z directions. Although the light emitting surface 40 and the irradiation surface 60 are illustrated to deviate in an up-down direction (+y direction) of the page plane of FIG. 2, the light emitting surface 40 and the irradiation surface 60 are actually disposed to face each other. The light emitting surface 40 of the light emitting unit 4 is located in a front side direction (−z direction) of the page plane of FIG. 2, and the irradiation surface 60 is located in a back side direction (+z direction) of the page plane of FIG. 2. That is, FIG. 2 illustrates a state of the light emitting unit 4 that emits light to the irradiation surface 60 as viewed from a side opposite to a side on which the light emitting unit 4 emits the light.

The light emitting unit 4 is configured with, for example, one or a plurality of light emitting chips. The light emitting unit 4 is an example of a light emitting device.

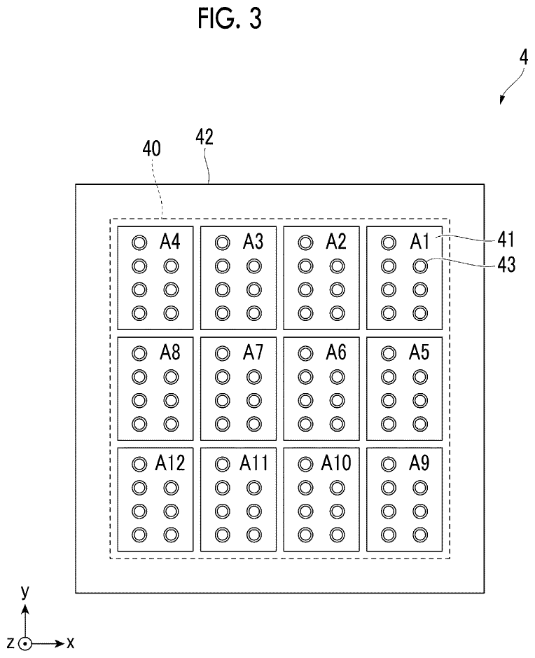

The light emitting unit 4 includes the light emitting surface 40 on which a plurality of vertical cavity surface emitting lasers (VCSELs, referred to by reference numeral 43 in FIG. 3 to be described below) are arranged. The light emitting unit 4 emits light toward the irradiation surface 60 by light emission of the VCSEL. The VCSEL is an example of a light emitting element. In FIG. 2, the VCSEL is not illustrated.

The light emitting surface 40 is divided into a plurality of light emitting sections 41 including at least one VCSEL. Here, as an example, the light emitting surface 40 is divided into 12 light emitting sections 41 in a total of four light emitting sections 41 in the x-direction and three light emitting sections 41 in the y-direction. As illustrated in FIG. 2, in a case where it is necessary to distinguish the light emitting sections 41 from each other, the light emitting sections 41 are distinguished as light emitting sections A1 to A12 in order from the upper left side (ends in the +x direction and the +y direction) in FIG. 2.

In the present specification, the term “to” indicates a plurality of components distinguished individually by numbers, and means that components before and after “to” and components having numbers between the components are included. For example, the light emitting sections A1 to A12 include 12 light emitting sections 41 from the light emitting section A1 to the light emitting section A12 in numerical order.

Each light emitting section 41 is independently driven by the light emission drive unit 6 (see FIG. 1) to perform a light emitting operation. In addition, each light emitting section 41 emits light by the light emission drive unit 6 supplying power to the VCSEL included in the light emitting section 41. In the present exemplary embodiment, the power supplied to the VCSEL included in each light emitting section 41 and the amount of light emitted from each light emitting section 41 associated with light emission of the VCSEL by the supplied power can be adjusted depending on an environment such as brightness of the irradiation range, an operation by a user of the distance measurement apparatus 1, or the like.

Further, in the present exemplary embodiment, the driving of the light emitting section 41 means that power is supplied to the VCSEL included in the light emitting section 41 to emit light, and the light emitting operation means that the VCSEL included in the light emitting section 41 emits the light for a predetermined light emitting period.

The term “independently driven” indicates that each light emitting section 41 is driven to enter a state for emitting the light. The light emission drive unit 6 drives each light emitting section 41 in response to a control signal from the control unit 8 (see FIG. 1). Thus, each light emitting section 41 does not always emit the light simultaneously, and for example, may be in a state in which, while the light emitting section A1 emits light, the light emitting section A12 does not emit light, as illustrated in FIG. 2.

The irradiation surface 60 is a surface that is perpendicular to a direction (+z direction) in which light is emitted at a certain distance from a center 40C of the light emitting surface 40, and irradiated with the light from the light emitting unit 4.

In the example in FIG. 2, the light emitting unit 4 emits light in the +z direction. Thus, the irradiation surface 60 extends in the x-direction and the y-direction at a certain distance in the +z direction. A central axis Ax (two-dot chain line) passing through a center 60C of the irradiation surface 60 and the center 40C of the light emitting surface 40 is perpendicular to the light emitting surface 40 and the irradiation surface 60. In the present exemplary embodiment, as the light emitting surface 40 has a rectangular shape, the irradiation surface 60 has a rectangular shape.

As illustrated in FIG. 2, the irradiation surface 60 is divided into a plurality of irradiation sections 61, corresponding to the light emitting sections 41 in the light emitting surface 40. In the example of FIG. 2, the irradiation surface 60 is divided into 12 irradiation sections 61 of four irradiation sections 61 in the x-direction and three irradiation sections 61 in the y-direction. In a case where it is necessary to distinguish the irradiation sections 61 from each other, irradiation sections B1 to B12 are referred to in order from the upper left side (ends in the +x direction and the +y direction) in FIG. 2.

A light emitting section Ai to which the same number i as a number of a certain irradiation section Bi is assigned may be referred to as a “corresponding light emitting section”. For example, the light emitting section A1 is a light emitting section corresponding to the irradiation section B1. On the contrary, an irradiation section Bi to which the same number i as a number of a certain light emitting section Ai is assigned may be referred to as a “corresponding irradiation section”.

The irradiation sections B1 to B12 have a plane-symmetrical arrangement to the light emitting sections A1 to A12 based on an xy plane. For example, in FIG. 2, as the irradiation sections B1, B2, B3, and B4 are arranged in this order in the −x direction, the light emitting sections A1, A2, A3, and A4 are arranged in this order in the −x direction.

Each light emitting section 41 emits light toward the corresponding irradiation section 61. Each irradiation section 61 is irradiated with the light emitted from the corresponding light emitting section 41. Here, the fact that the light emitting section 41 emits the light toward the corresponding irradiation section 61 means that an optical axis of the light emitted from each light emitting section 41 faces the corresponding irradiation section 61, and all of the light emitted from the light emitting section 41 is not limited to being emitted onto the corresponding irradiation section 61. In other words, in some cases, a part of the light emitted from a certain light emitting section 41 may be emitted onto the irradiation section 61 different from the corresponding irradiation section 61 or outside a range of the irradiation surface 60.

FIG. 3 is a diagram illustrating an example of the light emitting unit 4 according to the present exemplary embodiment. FIG. 3 illustrates a state of the light emitting unit 4 as viewed from a light emission side, contrary to FIG. 2. Accordingly, a right direction of the page plane of FIG. 3 is the +x direction, an upward direction of the page plane of FIG. 3 is the +y direction, and a front direction of the page plane of FIG. 3 is the +z direction.

As illustrated in FIG. 3, the light emitting unit 4 has a substrate 42, and the light emitting surface 40 on which a plurality of VCSELs 43 are disposed. In more detail, the substrate 42 and the light emitting surface 40 are provided to overlap with each other in a direction (the +z direction or the front direction of the page plane of FIG. 3) in which light is emitted. In addition to wiring for supplying power or exchanging electric signals, electronic components related to the operation of the light emitting unit 4 may be formed or attached on the substrate 42, and the description thereof will be omitted.

As described above, the light emitting unit 4 includes the 12 light emitting sections 41 (light emitting sections A1 to A12) in which the VCSELs 43 are arranged on the light emitting surface 40. As illustrated in FIG. 3, the light emitting sections A1 to A12 all have the same area. In addition, the same number (7 in this example) of VCSELs 43 are arranged in each of the light emitting sections A1 to A12.

The area of each light emitting section 41 and the number of VCSELs 43 to be arranged are not limited, and some or all of the light emitting sections 41 may have different areas from each other, and different numbers of VCSELs 43 may be arranged at some or all of the light emitting sections 41.

The light emitted from each light emitting section 41 of the light emitting unit 4 is spread with a plane perpendicular to the emission direction (the axial direction of the central axis Ax) by a diffusion unit (not illustrated) and is emitted to the irradiation surface 60. As the diffusion unit, an optical member such as a diffusion plate that is provided on an optical path of the light to diffuse the light with scattering or the like, and a diffractive optical element (DOE) or/and a lens that changes an angle of the incident light and emits the light can be used.

### Light Receiving Unit 5

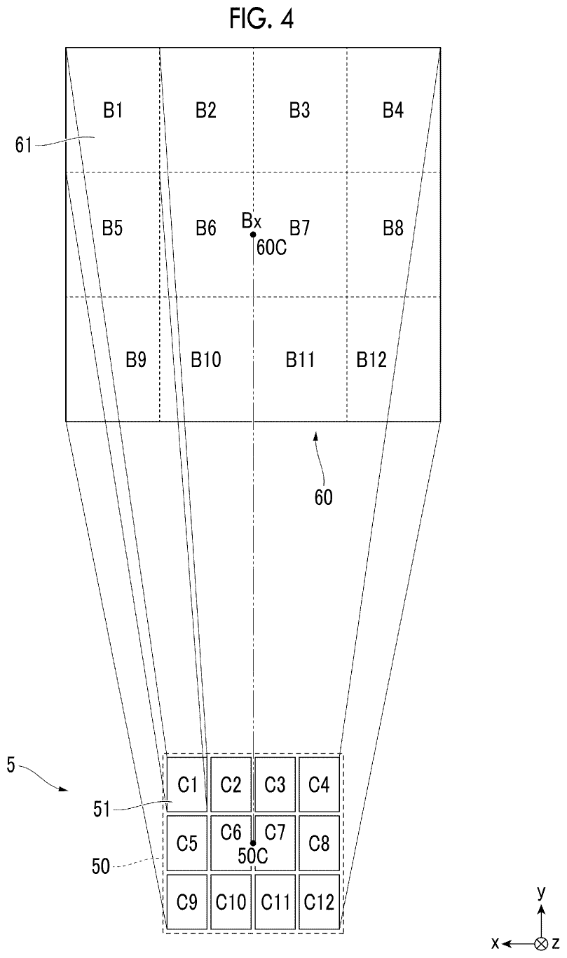

FIG. 4 is a diagram illustrating a relationship between a light receiving surface 50 of the light receiving unit 5 according to the present exemplary embodiment and the irradiation surface 60 described above. In the same manner as FIG. 2, a left direction of the page plane of FIG. 4 is a +x direction, an upward direction of the page plane of FIG. 4 is a +y direction, a back side direction of the page plane of FIG. 4 is a +z direction, and each opposite directions are −x, −y, and −z directions. Although the light receiving surface 50 and the irradiation surface 60 are illustrated to deviate in the up-down direction (+y direction) of the page plane of FIG. 4, the light receiving surface 50 and the irradiation surface 60 are actually disposed to face each other. The light receiving unit 5 (light receiving surface 50) is located in the front side direction (−z direction) of the page plane of FIG. 4, and the irradiation surface 60 is located in the back side direction (+z direction) of the page plane of FIG. 4. That is, FIG. 4 illustrates a state of the light receiving unit 5 that receives light reflected from the irradiation surface 60 as viewed from a side opposite to a side on which the light receiving unit 5 receives the light.

The light receiving unit 5 extends in the x-direction and the y-direction, and includes the light receiving surface 50 in which a plurality of light receiving elements (not illustrated) are arranged. The light receiving unit 5 receives the light emitted from the light emitting unit 4 and reflected by a target object existing at the irradiation surface 60, by each light receiving element.

A central axis Bx (two-dot chain line) passing through the center 60C of the irradiation surface 60 and a center 50C of the light receiving surface 50 is perpendicular to the irradiation surface 60 and the light receiving surface 50. In the present exemplary embodiment, in the same manner as the light emitting surface 40 (see FIG. 2) and the irradiation surface 60, the light receiving surface 50 has a rectangular shape.

The light receiving surface 50 is divided into a plurality of light receiving sections 51 corresponding to the light emitting sections 41 (see FIG. 2) of the light emitting surface 40 (see FIG. 2) and the irradiation sections 61 of the irradiation surface 60. In the example of FIG. 4, the light receiving surface 50 is divided into 12 light receiving sections 51 of four light receiving sections 51 in the x-direction and three light receiving sections 51 in the y-direction. In a case where it is necessary to distinguish the light receiving sections 51 from each other, the light receiving sections 51 are distinguished as light receiving sections C1 to C12 in order from the upper left side (ends in the +x direction and +y direction) in FIG. 4.

A light receiving section Ci to which the same number i as a number of a certain light emitting section Ai and a certain irradiation section Bi is assigned may be referred to as a “corresponding light receiving section”. For example, the light receiving section C1 is a light receiving section corresponding to the light emitting section A1 or the irradiation section B1. On the contrary, the light emitting section Ai to which the same number as a number of a certain light receiving section Ci is assigned is referred to as a “corresponding light emitting section”, and the irradiation section Bi to which the same number as a number of a certain light receiving section Ci is assigned is referred to as “corresponding irradiation section”, in some cases.

The light receiving sections C1 to C12 have a plane-symmetrical arrangement to the irradiation sections B1 to B12 based on the xy plane. For example, in FIG. 4, as the irradiation sections B1, B2, B3, and B4 are arranged in this order in the −x direction, the light receiving sections C1, C2, C3, and C4 are arranged in this order in the −x direction.

Each light receiving section 51 receives light emitted from the light emitting unit 4 and reflected by a target object existing at the corresponding irradiation section 61.

Each light receiving section 51 has a plurality of light receiving elements that are regularly arranged. Each light receiving element can receive light emitted from the light emitting unit 4 and reflected by a target object existing at the irradiation surface 60, and can output an electric signal in response to the received light. Examples of the light receiving element include a photodiode or a phototransistor.

Each light receiving section 51 is independently driven by the light reception drive unit 7 (see FIG. 1) to perform a light receiving operation. Here, the drive of the light receiving section 51 means that the light receiving section 51 is in a state capable of accumulating a charge corresponding to the light reception of the light receiving element, and the light receiving operation means that the light receiving element of the light receiving section 51 accumulates the charge in response to the light reception. In addition, the term “independently driven” indicates that each light receiving section 51 is driven to enter a state in which the charge can be accumulated in response to the light reception. The light reception drive unit 7 drives each light receiving section 51 in response to a control signal from the control unit 8 (see FIG. 1).

In addition, the light receiving unit 5 outputs an electric signal corresponding to the charge accumulated in the light receiving section 51, that is, a result of the light received in the light receiving section 51 to the control unit 8, in accordance with a read operation of the control unit 8 (details will be described below).

### Control Unit 8

With reference to FIG. 1, the control unit 8 is configured with a central processing unit (CPU) 81, a read only memory (ROM) 82, and a random access memory (RAM) 83.

The CPU 81 is an example of a processor, and implements each function, which will be described below, by loading various programs stored in the ROM 82 or the like into the RAM 83 and executing the programs. The RAM 83 is a memory used as a work memory or the like of the CPU 81. The ROM 82 is a memory which stores various programs and the like executed by the CPU 81.

Here, the program executed by the CPU 81 may be provided in a state of being stored in a computer-readable recording medium such as a magnetic recording medium (a magnetic tape, a magnetic disk, or the like), an optical recording medium (an optical disk or the like), a magnetooptical recording medium, or a semiconductor memory. The program executed by the CPU 81 may be provided by using a communication section such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively.

The order of operations of the processor is not limited to one described in the embodiments above, and may be changed.

The control unit 8 controls the light emitting operation of the light emitting unit 4 through the light emission drive unit 6, and controls the light receiving operation of the light receiving unit 5 through the light reception drive unit 7.

In addition, the control unit 8 performs a read operation on the light receiving unit 5 through the light reception drive unit 7. Here, the term “read operation” means that the control unit 8 controls the light receiving unit 5 through the light reception drive unit 7 and causes the light receiving unit 5 to output an electric signal corresponding to a result of light reception by the light receiving element in the light receiving section 51, and acquires the electric signal as the result of the light reception for each light receiving section 51. The control unit 8 according to the present exemplary embodiment can independently perform the read operation for each light receiving section 51. For example, in a case where a certain light receiving section Ci and another light receiving section Cj perform a light receiving operation to accumulate a charge, not only a read operation can be performed on both the light receiving section Ci and the light receiving section Cj but also the read operation can be performed on only the light receiving section Ci.

Meanwhile, in general, in the indirect ToF method, light is received with a plurality of phase differences with respect to emission of light, and a difference between the phase of the emitted light and the phase of the received light is obtained from the result of the light reception at each phase difference to measure a distance. Further, in general, in order to reduce a decrease in distance measurement accuracy by external light (ambient light), light reception is performed a plurality of times for one phase difference. Therefore, in a case where light reception is performed k times at each of n phase differences φ (φ1, φ2, . . . , and φn), emission of light, reception of the light at a certain phase difference φ, and reading of a result of the light reception are repeated n×k times.

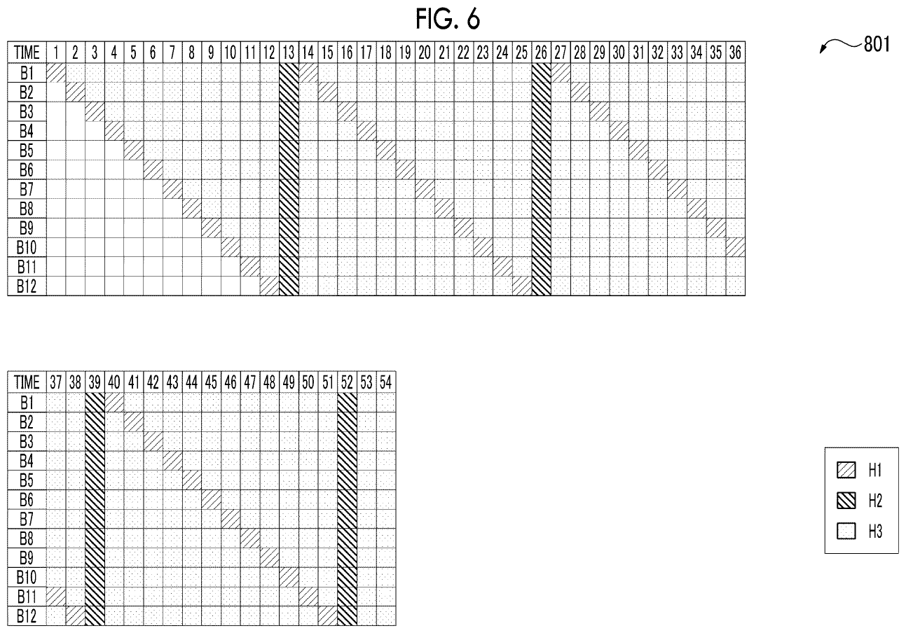

In the distance measurement apparatus 1 to which the present exemplary embodiment is applied, a distance is measured based on the indirect ToF method, from a result of performing light reception twice at each of two phase differences q of 0 degrees and 180 degrees with respect to emission of light. Thus, in a case of performing distance measurement of, for example, a certain irradiation section Bi in the distance measurement apparatus 1, a light emitting operation in the corresponding light emitting section Ai, a light receiving operation in the corresponding light receiving section Ci, and a read operation for the light receiving section Ci by the control unit 8 are respectively repeated 4 times. More specifically, in the distance measurement apparatus 1, four light emitting operations in each light emitting section 41, four light receiving operations in each light receiving section 51, and four read operations for each light receiving section 51 are performed according to a predetermined operation pattern. Details of the predetermined operation pattern will be described below with reference to FIG. 6.

The control unit 8 performs distance measurement of each irradiation section 61, based on a result of light reception in each light receiving section 51. The results of distance measurement in each irradiation section 61 are collected, and a distance image representing the distance between the distance measurement apparatus 1 and the target object is created. More specifically, the control unit 8 calculates (performs distance measurement) a distance between the distance measurement apparatus 1 and the target object in each irradiation section 61 of the irradiation surface 60 by performing a predetermined arithmetic process on four electric signals acquired from the light receiving unit 5 as a result of the four light receptions in each light receiving section 51, and creates a distance image.

### Distance Image 100

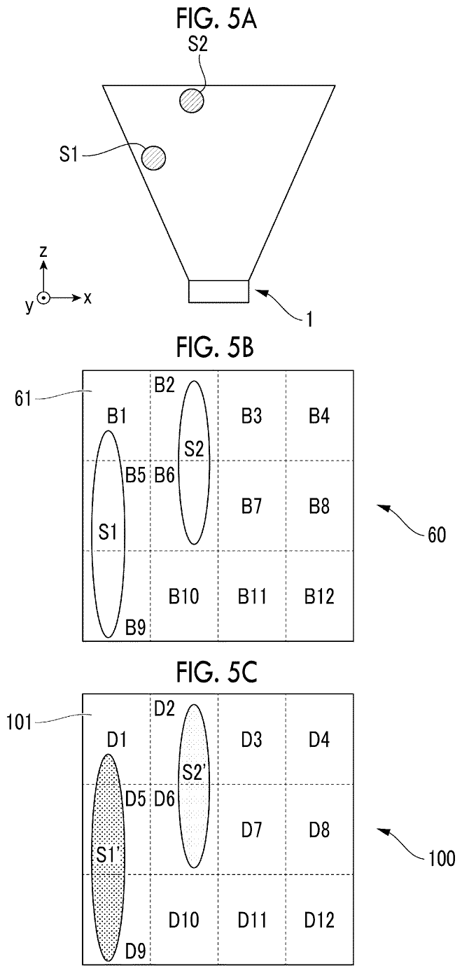

FIGS. 5A to 5C are diagrams describing a distance image 100 according to the present exemplary embodiment, FIG. 5A is a diagram illustrating a positional relationship between the distance measurement apparatus 1 and target objects S1 and S2, FIG. 5B is a diagram illustrating a state of the irradiation surface 60, and FIG. 5C is a diagram illustrating an example of the distance image 100 created by the control unit 8.

The distance image 100 illustrated in FIG. 5C is created as a result of performing distance measurement on all the irradiation sections 61 of the irradiation surface 60. In the example of FIGS. 5A to 5C, it is assumed that the target objects S1 and S2 (may be referred to as a target object S without distinguishing the target objects S1 and S2) are stopped at least from a start to an end of distance measurement required for creating the distance image 100 by the distance measurement apparatus 1 and a position with respect to the distance measurement apparatus 1 is not changed.

As illustrated in FIG. 5C, the distance image 100 has a plurality of image sections 101 corresponding to the light emitting sections 41 of the light emitting surface 40, the irradiation sections 61 of the irradiation surface 60, and the light receiving sections 51 of the light receiving surface 50 (see FIGS. 2 and 4). In the example of FIG. 5C, the distance image 100 has 12 image sections 101 of four image sections 101 arranged in the right-left direction of FIG. 5C corresponding to the ±x direction of the irradiation surface 60 and the light receiving surface 50, and three image sections 101 arranged in the up-down direction of FIG. 5C corresponding to the ty direction. In a case where it is necessary to distinguish the image sections 101 from each other, image sections D1 to D12 are distinguished in order from the upper left side in FIG. 5C.

An image section Di in the distance image 100 is an image obtained based on light emitted by the light emitting section Ai of the light emitting surface 40, reflected by the target object at the irradiation section Bi of the irradiation surface 60, and received in the light receiving section Ci of the light receiving surface 50. The image section Di to which the same number i as a number of the light emitting section Ai, the irradiation section Bi, and the light receiving section Ci is assigned may be referred to as a “corresponding image section”. On the contrary, in some cases, the light emitting section Ai to which the same number i as a number of the image section Di is assigned is referred to as a “corresponding light emitting section”, the irradiation section Bi to which the same number i as a number of the image section Di is assigned is referred to as a “corresponding irradiation section”, and the light receiving section Ci to which the same number i as a number of the image section Di is assigned is referred to as a “corresponding light receiving section”.

Each image section 101 of the distance image 100 has a plurality of pixels (not illustrated) associated with the plurality of light receiving elements included in the corresponding light receiving section 51. In the distance image 100, a pixel value of each pixel of the image section 101 corresponds to a distance from the distance measurement apparatus 1 to the target object, which is calculated from the electric signal from each light receiving element of the light receiving section 51.

In the example illustrated in FIG. 5A, the target objects S1 and S2 exist at positions separated from the distance measurement apparatus 1 by a certain distance. As illustrated in FIG. 5B, the target object S1 in this example exists in a range across the irradiation sections B1, B5, and B9 of the irradiation surface 60, and the target object S2 exists in a range across the irradiation sections B2 and B6. Further, a distance from the distance measurement apparatus 1 to the target object S1 (for example, approximately 1 m) is smaller than a distance from the distance measurement apparatus 1 to the target object S2 (for example, approximately 3 m).

As illustrated in FIG. 5C, in the distance image 100, an image S1′ representing the target object S1 and an image S2′ representing the target object S2 (may be referred to as an image S′ without distinguishing the image S1′ and the image S2′) are illustrated by pixels included in each image section 101. More specifically, the image S1′ is illustrated across the image sections D1, D5, and D9 corresponding to the irradiation sections B1, B5, and B9 in the distance image 100, and the image S2′ is illustrated across the image sections D2 and D6 corresponding to the irradiation sections B2 and B6 in the distance image 100.

In this example, information on a distance from the distance measurement apparatus 1 to the target object S1 and a distance from the distance measurement apparatus 1 to the target object S2 can be obtained by pixel values (represented by shading in FIG. 5C) of pixels constituting the image S1′ and the image S2′ in the distance image 100.

Since the distance image 100 includes information on a distance between each point on a surface of the target object S and the distance measurement apparatus 1, the distance image 100 may be considered to include information on a three-dimensional shape of the target object S. Thus, the distance measurement apparatus 1 to which the present exemplary embodiment is applied can also be used for three-dimensional measurement.

### Operation Pattern

Meanwhile, in a case where each light emitting section 41 of the light emitting unit 4 performs a light emitting operation as in the distance measurement apparatus 1, four light emitting periods are provided. The four light emitting periods are an example of a predetermined plurality of (scheduled number of) light emitting periods in the present exemplary embodiment.

In such a distance measurement apparatus 1, in a case where it is assumed that an operation pattern of performing four light emitting operations in each light emitting section 41, four light receiving operations in each light receiving section 51, and four read operations on each light receiving section 51 is uniform handled, in some cases, it is difficult to perform distance measurement appropriate for a situation of a target object existing at the irradiation surface 60 and an influence of heat generation in each light emitting section 41.

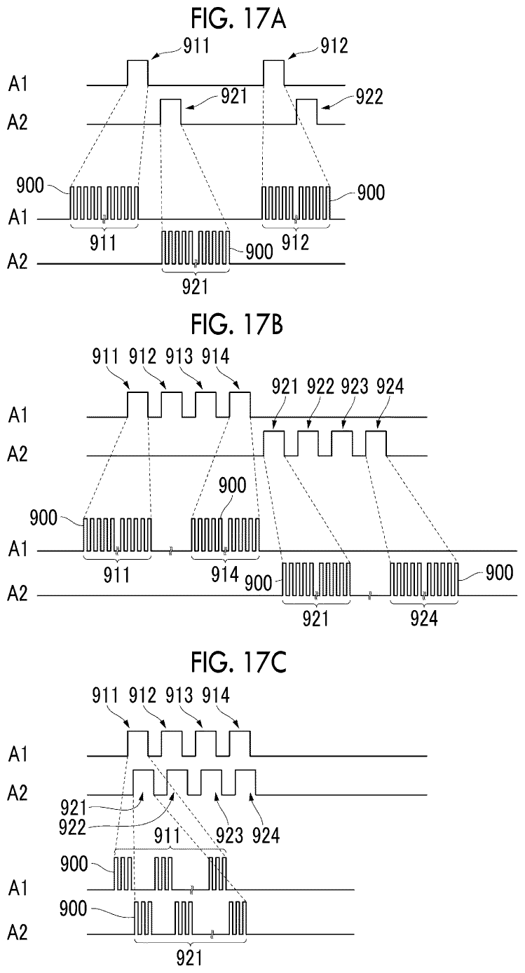

First, a light emitting operation of each light emitting section 41 will be described. FIGS. 17A to 17C are diagrams illustrating an example of a light emitting operation in one light emitting period of each light emitting section 41 (see FIGS. 2 and 3). FIGS. 17A to 17C illustrate an example of a light emitting operation by two light emitting sections A1 and A2 among the plurality of light emitting sections 41. Here, as the light emitting operation, each light emitting section 41 is driven by the light emission drive unit 6 (see FIG. 1), emits light by causing a VCSEL to emit a pulse having a width of approximately 10 ns to 100 ns a large number of times during 500 μs, and irradiates the corresponding irradiation section 61 with the light. More specifically, as illustrated in FIGS. 17A to 17C, one light emitting period (indicated by reference numerals 911 to 914) of the light emitting section A1 is configured with a large number of times of pulse 900. In the same manner, one light emitting period (indicated by reference numerals 921 to 924) of the light emitting section A2 is configured with a large number of times of pulse 900. The number of times of the pulse 900 with which light is emitted in one light emitting period of each light emitting section 41 varies depending on a width of the pulse 900, and may be, for example, approximately several tens to several hundreds. The light emitting period is not limited to 500 μs, and is determined in advance according to the amount of light or the like required to secure accuracy of distance measurement.

Here, as illustrated in FIG. 17A, each light emitting section 41 may perform the light emitting operation such that a light emitting period (for example, the light emitting period 921) of another light emitting section 41 (for example, the light emitting section A2) is included between light emitting periods (for example, light emitting periods 911 and 912) of one light emitting section 41 (for example, the light emitting section A1). In addition, as illustrated in FIG. 17B, each light emitting section 41 may perform the light emitting operation such that light emitting periods (light emitting period 921 to 924) of the other light emitting section 41 (light emitting section A2) are not included during four light emitting periods (light emitting periods 911 to 914) of one light emitting section 41 (light emitting section A1). Further, in each light emitting section 41, as illustrated in FIG. 17C, the light emitting operation may be performed such that the pulse 900 constituting the light emitting period (light emitting period 921) of another light emitting section 41 (light emitting section A2) is included between the pulses 900 constituting the light emitting period (light emitting period 911) of one light emitting section 41 (light emitting section A1).

The light emitting operation of each light emitting section 41 will be described in detail together with an operation pattern by the distance measurement apparatus 1.

Hereinafter, one of operation patterns by the distance measurement apparatus 1 according to the present exemplary embodiment will be described as an example.

FIG. 6 is a diagram illustrating a first operation pattern 801 which is one of the operation patterns of the distance measurement apparatus 1 to which the present exemplary embodiment is applied. In addition, in FIG. 6, the first operation pattern 801 is described separately in two stages (front-stage and back-stage).

Each light emitting section 41 is driven by the light emission drive unit 6 (see FIG. 1), emits light by causing a VCSEL to emit the light for 500 μs, and irradiates the corresponding irradiation section 61 with the light. The light emitting period is not limited to 500 μs, and is determined in advance according to the amount of light or the like required to secure the accuracy of distance measurement.

In FIG. 6, the item “time” in a first row indicates passage of time after the distance measurement apparatus 1 starts an operation related to distance measurement, and indicates that a time passes in a right direction in FIG. 6 (proceeds to the right column). The number illustrated in each column indicates an elapsed time using a number u in unit times. As the unit time, a time corresponding to a light emitting period of each light emitting section 41 is used, which is 500 μs in this example.

Further, in FIG. 6, the items “B1” to “B12” in a second row to a thirteenth row indicate which irradiation section 61 is the operation related to the distance measurement by using the reference numeral Bi (i=1 to 12) of the irradiation section 61 (see FIG. 2 and FIG. 4). That is, a cell in which a column of a time u and a row of the irradiation section Bi intersect with each other indicates an operation related to distance measurement of the irradiation section Bi at a time point at which a unit time×u elapses from a start of the operation related to the distance measurement by the distance measurement apparatus 1.

In FIG. 6, a shaded cell H1 (see legend on the right side in figures) indicates that the corresponding light emitting section Ai performs a light emitting operation and the corresponding light receiving section Ci performs a light receiving operation. That is, the shaded cell H1 corresponds to a light emitting period of the corresponding light emitting section Ai.

Further, in FIG. 6, a shaded cell H2 (see legend) indicates that the control unit 8 performs a read operation on the corresponding light receiving section Ci. In the distance measurement apparatus 1 to which the present exemplary embodiment is applied, the description will be made assuming that the control unit 8 requires one time of unit time, 500 μs, for the read operation on the light receiving section 51.

Further, in FIG. 6, a shaded cell H3 (see legend) is a light non-emitting period during which the corresponding light emitting section Ai does not emit light, and indicates a period secured as a predetermined cooling period for reducing the influence of heat generation associated with light emission in the light emitting section Ai. Since it is possible to provide the read operation period and the cooling period in parallel by the control unit 8 in the distance measurement apparatus 1, in that case, the shaded cell H2 is preferentially executed. A length of the cooling period in the first operation pattern 801 illustrated in FIG. 6 will be described in detail below.

Here, in a case where a plurality of light emitting periods are provided for the light emitting section 41, a light non-emitting period during which the light emitting section 41 does not emit light is provided between the light emitting period and the next light emitting period. In this light non-emitting period, the light emitting section 41 performs heat dissipation and is cooled. In addition, the light non-emitting period is used as a cooling period of the light emitting section 41 for reducing a temperature of the light emitting section 41 from becoming too high due to heat generated by the light emission of the VCSEL.

In the first operation pattern 801 illustrated in FIG. 6, at a time when an operation related to distance measurement of the irradiation section Bi is not completed, an operation related to distance measurement of the next irradiation section Bj (j=i+1) is started. Here, the completion of the operation related to the distance measurement of the irradiation section Bi means that the scheduled number of four light emitting operations and light receiving operations and a read operation corresponding to each light receiving operation are completed and data necessary for the distance measurement of the irradiation section Bi is prepared.

More specifically, in a light non-emitting period of the light emitting section Ai between a light emitting period and the next light emitting period of the light emitting section Ai corresponding to a certain irradiation section Bi, a light emitting period of the next light emitting section Aj (j=i+1) is provided. In this example, the light emitting section Ai is an example of a first light emitting section, and the light emitting section Aj is an example of a second light emitting section. In addition, in this example, in a case where the light emitting section A1 is set as a first light emitting section, the light emitting sections A2 to A12 having light emitting periods included in a light non-emitting period of the light emitting section A1 correspond to second light emitting sections. Further, in this example, the number of the second light emitting sections having the light emitting period included in the light non-emitting period of the first light emitting section is 11.

Details will be described with reference to FIG. 6. In the time u=1 of the first operation pattern 801, a light emitting operation in the light emitting section A1 corresponding to the irradiation section B1 and a light receiving operation at the phase difference φ=0 degrees in the corresponding light receiving section C1 are performed. Next, in the time u=2, a light emitting operation in the light emitting section A2 corresponding to the irradiation section B2 and a light receiving operation at the phase difference φ=0 degrees in the corresponding light receiving section C2 are performed. Further, in the time u=3, a light emitting operation in the light emitting section A3 corresponding to the irradiation section B3 and a light receiving operation at the phase difference φ=0 degrees in the corresponding light receiving section C3 are performed. This operations are repeated, and in the time u=12, in a case where the light emitting operation in the light emitting section A12 corresponding to the last irradiation section B12 and the light receiving operation at the phase difference φ=0 degrees in the corresponding light receiving section C12 are performed, in the time u=13, the control unit 8 performs read operations for all the light receiving sections 51 (C1 to C12). Accordingly, the control unit 8 acquires a result of the light reception at the first phase difference φ=0 degrees for all the irradiation sections 61. In and after the time u=14, in the same manner, a result of light reception at the second phase difference φ=0 degrees, a result of light reception at the first phase difference φ=180 degrees, and a result of light reception at the second phase difference Q=180 degrees are acquired. In the time u=52, the control unit 8 performs the fourth read operation on the light receiving sections C1 to C12, so that the distance measurement of all the irradiation sections 61 (B1 to B12) is completed.

In the example of FIG. 6, the light emitting operations of the light emitting sections A1 to A12 are performed in numerical order, and the order of performing the light emitting operations is not limited. In the same manner, the order can be changed in the other operation patterns.

In this manner, in the first operation pattern 801, after the light emitting operation of the light emitting section Ai and the light receiving operation of the light receiving section Ci, the light emitting operation of the next light emitting section Aj and the light receiving operation of the next light receiving section Cj are performed, and after the light receiving operation is completed once for all the irradiation sections 61, the read operations for all the light receiving sections 51 are performed. This is repeated 4 times, and by completing the read operation of the result of the fourth light reception, the distance measurement of all the irradiation sections 61 is completed, and data necessary for creating the distance image 100 (see FIG. 5C) by the control unit 8 is prepared. As illustrated in FIG. 6, in the first operation pattern 801, a time until the distance measurement of all the irradiation sections 61 is completed is the unit time u×52 (=26.0 ms).

Further, in the first operation pattern 801, after one light emitting period in the light emitting section Ai, a light emitting period of another light emitting section Aj (j=i+1) is provided. As illustrated in FIG. 6, in the first operation pattern 801, a time until the scheduled number of four light emitting periods in all the light emitting sections 41 are completed is the unit time u×51 (=25.5 ms).

Further, in the first operation pattern 801, an interval between a first light emitting operation of the light emitting section Ai and a first light receiving operation of the light receiving section Ci, and a second light emitting operation of the light emitting section Ai and a second light receiving operation of the light receiving section Ci is the unit time u×12 (6.0 ms). In the first operation pattern 801, a period after the first light emitting operation of the light emitting section Ai and the first light receiving operation of the light receiving section Ci are completed until the second light emitting operation of the light emitting section Ai and the second light receiving operation of the light receiving section Ci are started corresponds to a light non-emitting period of the light emitting section Ai.

In the distance measurement apparatus 1, the period after the first light emitting operation of the light emitting section Ai and the first light receiving operation of the light receiving section Ci are completed until the second light emitting operation of the light emitting section Ai and the second light receiving operation of the light receiving section Ci are started is a period that can be allocated as a cooling period of the light emitting section Ai. That is, in the first operation pattern 801, a period of the unit time u×12 (6.0 ms) can be allocated as the cooling period of the light emitting section Ai.

Here, in a case where the target object S (see FIG. 5A) is a moving object and an interval (may be referred to as a distance measurement interval) between the light emitting operation of the light emitting section 41 and the light receiving operation of the light receiving section 51 and the next light emitting operation of the light emitting section 41 and the next light receiving operation of the light receiving section 51 for a certain irradiation section 61 of the distance measurement apparatus 1 is large, an effect of motion artifacts may be large. More specifically, for example, in a case where an interval between a first light emitting operation of the light emitting section 41 and a first light receiving operation of the light receiving section 51 corresponding to the certain irradiation section 61, and a second light emitting operation of the same light emitting section 41 and a second light receiving operation of the light receiving section 51 is large, the movement of the target object S becomes larger during this interval, and a large difference occurs between the result of the first light reception and the result of the second light reception. This difference in result of the light reception affects a result of distance measurement as a motion artifact. For example, a large error occurs in the distance to the target object S, and an image S′ may be illustrated in a shape different from a shape of the actual object S in the distance image 100 (see FIG. 5C), which may lead to a decrease in accuracy of the distance measurement.

On the other hand, in a case where for the certain irradiation section 61 of the distance measurement apparatus 1, the interval between the light emitting operation of the light emitting section 41 and the light receiving operation of the light receiving section 51, and the next light emitting operation of the light emitting section 41 and the next light receiving operation of the light receiving section 51 is small, the period secured as the cooling period of the light emitting section 41 is reduced. In this case, a temperature of the light emitting section 41 becomes too higher due to heat generated by the light emission of the VCSEL, which may have an effect of a decrease in light output of the VCSEL, a decrease in life, or the like. The cooling period of each light emitting section 41 required to reduce the influence of heat generation associated with light emission varies depending on the amount of light emitted from the light emitting section 41 by the power supplied to the VCSEL.

On the other hand, in the distance measurement apparatus 1 according to the present exemplary embodiment, the operation patterns are switched according to the amount of light emitted from the light emitting section 41 by the power supplied to the VCSEL, the situation of the target object S existing at the irradiation surface 60 (see FIG. 5B), and the like.

Specifically, in the distance measurement apparatus 1 according to the present exemplary embodiment, first, according to the amount of light emitted from the light emitting section 41 by the power supplied to the VCSEL, the situation of the target object S existing at the irradiation surface, and the like, another light emitting section 41, which is an example of the second light emitting section, of which a light emitting period is to be included in a light non-emitting period of the light emitting section 41, which is an example of the first light emitting section is switched. Although details will be described below, switching the second light emitting section having the light emitting period to be included in the light non-emitting period of the first light emitting section means that at least one of the number of second light emitting sections having the light emitting period to be included in the light non-emitting period of the first light emitting section or a position of the second light emitting section with respect to the first light emitting section. In addition, the number of the second light emitting sections having the light emitting period to be included in the light non-emitting period of the first light emitting section includes zero.

### Switching of Operation Pattern Based on Amount of Light of Light Emitting Section 41

First, an aspect in which the distance measurement apparatus 1 switches an operation pattern according to the amount of light emitted from the light emitting section 41 will be described.

As described above, in the distance measurement apparatus 1, a cooling period of each light emitting section 41 required for reducing an influence of heat generation associated with light emission of a VCSEL varies depending on the amount of light emitted from the light emitting section 41 by power supplied to the VCSEL. That is, in general, the larger the power supplied to the VCSEL, the larger the amount of light emitted from each light emitting section 41 due to the light emission of the VCSEL. As the amount of light emitted from the light emitting section 41 becomes larger, the amount of heat generated by the light emission of the VCSEL becomes larger and the cooling period of each light emitting section 41 required to reduce the influence of the heat generation is likely to be reduced.

In the distance measurement apparatus 1 according to the present exemplary embodiment, as the amount of light emitted from the light emitting section 41 is increased, the number of other light emitting sections 41 having a light emitting period to be included in a light non-emitting period of the light emitting section 41 is increased. In addition, in the distance measurement apparatus 1 according to the present exemplary embodiment, as the cooling period of each light emitting section 41 required for reducing the influence of heat generation associated with light emission is increased, the number of other light emitting sections 41 having the light emitting period to be included in the light non-emitting period of the light emitting section 41 is increased. Further, in the distance measurement apparatus 1 according to the present exemplary embodiment, the number of other light emitting sections 41 is determined such that a sum of an acquisition period required for the control unit 8 to perform a read operation on each light receiving section 51 and the light emitting period of the other light emitting section 41 having the light emitting period to be included in the light non-emitting period of the light emitting section 41 does not fall below the cooling period of each light emitting section 41 required for reducing the influence of heat generation associated with the light emission.

Accordingly, the distance measurement apparatus 1 secures a cooling period required for reducing the influence of heat generation associated with the light emission of the light emitting section 41 in the light non-emitting period of the light emitting section 41.

In the present exemplary embodiment, the amount of light emitted from the light emitting section 41 is an example of an index that is changed due to heat generation in the light emitting section 41.

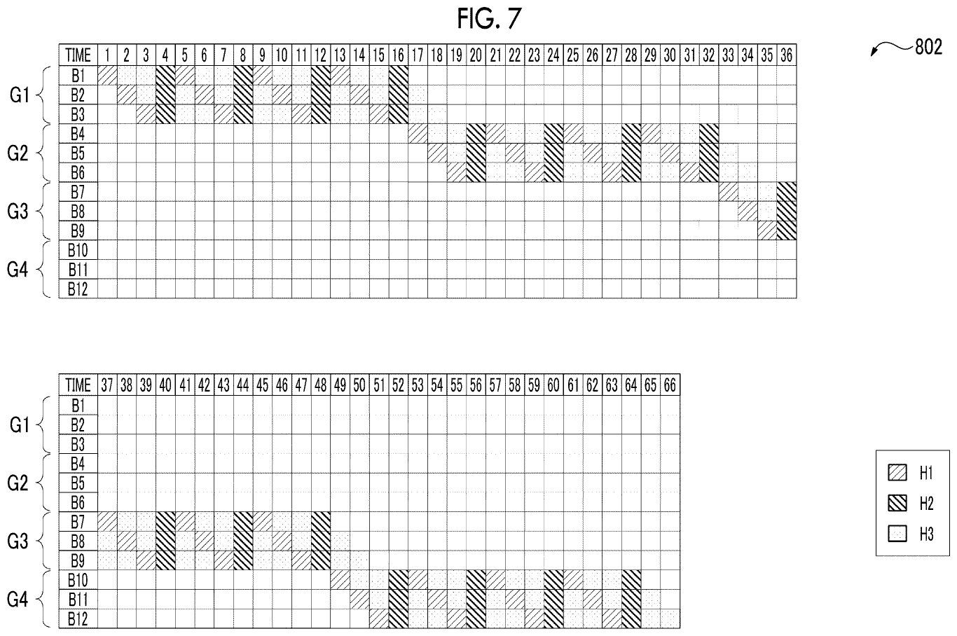

FIG. 7 is a diagram illustrating a second operation pattern 802 of the distance measurement apparatus 1 to which the present exemplary embodiment is applied.

In this example, in the distance measurement apparatus 1, depending on the amount of light emitted from the light emitting section 41, a light emitting operation by each light emitting section 41, a light receiving operation by each light receiving section 51, and a read operation on each light receiving section 51 are performed according to the first operation pattern 801 illustrated in FIG. 6 or the second operation pattern 802 illustrated in FIG. 7.

First, the second operation pattern 802 illustrated in FIG. 7 will be described.

In FIG. 7 to FIG. 16B to be described below, contents indicated by each item of H1 to H3 in a first row to a thirteenth row have the same manner as the corresponding notations in FIG. 6. Further, in each of FIG. 7 to FIG. 16B, an operation pattern may be described separately in two stages (front-stage and back-stage). Further, in the same manner as the first operation pattern 801 described with reference to FIG. 6, in any operation pattern, a case where a light emitting period of each light emitting section 41 is 500 μs will be described as an example.

In the second operation pattern 802, the irradiation sections 61, the corresponding light emitting sections 41, and the corresponding light receiving sections 51 are divided into a plurality of groups, and an operation of the distance measurement apparatus 1 is defined based on this grouping. As illustrated in FIG. 7, the irradiation sections B1 to B3 belong to a group G1, the irradiation sections B4 to B6 belong to a group G2, the irradiation sections B7 to B9 belong to a group G3, and the irradiation sections B10 to B12 belong to a group G4. In addition, each light emitting section Ai and each light receiving section Ci belong to the same group as the corresponding irradiation section Bi. Hereinafter, these groups G1 to G4 may be referred to as a group G without distinguishing the groups G1 to G4.

In the second operation pattern 802 illustrated in FIG. 7, after an operation related to distance measurement of a group Gi is completed, an operation related to distance measurement of a group Gj (j=i+1) is started. From the viewpoint of a light emitting operation, in a light non-emitting period of the light emitting section Ai belonging to the group Gi, a light emitting period of the light emitting section Aj (j≠i) belonging to the same group Gi is provided. After the scheduled number of four light emitting periods in the light emitting sections Ai and Aj belonging to the group Gi, a light emitting period of a light emitting section Ak (k≠i, j) belonging to the group Gj is provided. In this example, the light emitting section Ai is an example of a first light emitting section, the light emitting section Aj is an example of a second light emitting section, the group Gi is an example of one light emitting section group, and the group Gj is an example of another light emitting section group. In addition, in the second operation pattern 802, in a case where the light emitting section A1 is set as a first light emitting section, the light emitting sections A2 and A3 having light emitting periods included in a light non-emitting period of the light emitting section A1 correspond to second light emitting sections. Further, in the second operation pattern 802, the number of the second light emitting sections having the light emitting period included in the light non-emitting period of the first light emitting section is 2. That is, in the second operation pattern 802, the number of second light emitting sections having the light emitting period included in the light non-emitting period of the first light emitting section is smaller than the number of second light emitting sections of the first operation pattern 801.

As illustrated in FIG. 7, in the second operation pattern 802, in the time u=1, the light emitting section A1 corresponding to the irradiation section B1 performs a light emitting operation, and the corresponding light receiving section C1 performs a light receiving operation at the first phase difference φ=0 degrees. Further, in the time u=2, the light emitting section A2 corresponding to the irradiation section B2 performs the light emitting operation, and the corresponding light receiving section C2 performs a light receiving operation. Further, in the time u=3, the light emitting section A3 corresponding to the irradiation section B3 performs the light emitting operation, and the corresponding light receiving section C3 performs the light receiving operation. In the time u=4, the control unit 8 performs a read operation for each of the light receiving sections C1 to C3. Accordingly, the distance measurement apparatus 1 (control unit 8) acquires a result of the first light reception at the phase difference φ=0 degrees in the irradiation sections B1 to B3 belonging to the group G1. That is, in the second operation pattern 802, after the light emitting period is completed once for all the light emitting sections A1 to A3 belonging to the group G1, the control unit 8 acquires the result of the light reception by the light receiving sections C1 to C3 between a start of the light emitting period of the first light emitting section A1 and an end of the light emitting period of the last light emitting section A3. In the same manner, in the time u=5 to 8, a result of second light reception at the phase difference φ=0 degrees is acquired, in the time u=9 to 12, a result of first light reception at the phase difference φ=180 degrees is obtained, and in the time u=13 to 16, a result of second light reception at the phase difference φ=180 degrees is acquired. In this manner, in the time u=1 to 16, four light emitting operations in the light emitting sections A1 to A3 corresponding to the irradiation sections B1 to B3 of the group G1, four light receiving operations in the corresponding light receiving sections C1 to C3, and four read operations on the light receiving sections C1 to C3 by the control unit 8 are performed. In other words, in the time u=16, the scheduled number of four light emitting operations, light receiving operations, and read operations for all the irradiation sections B1 to B3 belonging to the group G1 are completed, and the operation related to the distance measurement of the group G1 is completed.

In a case where the operation related to the distance measurement of the group G1 is completed, in the time u=17, the light emitting section A4 corresponding to the irradiation section B4 performs a light emitting operation and the corresponding light receiving section C4 performs a light receiving operation at the first phase difference φ=0 degrees, and thus an operation related to distance measurement of the group G2 is started. Further, in the same manner as the group G1, the light emitting sections A4 to A6 belonging to the group G2 perform the scheduled number of four light emitting operations, the light receiving sections C4 to C6 perform the scheduled number of four light receiving operations, and the control unit 8 performs four read operations, and thus the operation related to the distance measurement of the group G2 is completed in the time u=32. In the same manner, an operation related to distance measurement of the group G3 is performed in the time u=33 to 48, and an operation related to distance measurement of the group G4 is performed in the time u=49 to 64. Thus, in the second operation pattern 802, the distance measurement of all the irradiation sections 61 (B1 to B12) is completed.

In this manner, in the second operation pattern 802, by performing the fourth read operation on the last group G4, the distance measurement of all the irradiation sections 61 is completed, and data necessary for creating the distance image 100 (see FIG. 5C) by the control unit 8 is prepared. As illustrated in FIG. 7, in the second operation pattern 802, a time until the distance measurement of all the irradiation sections 61 is completed is the unit time u×64 (=32.0 ms). In addition, a time until the scheduled number of four light emitting periods in all the light emitting sections 41 are completed is the unit time u×63 (=31.5 ms).

Further, in the second operation pattern 802, an interval between a first light emitting operation of the light emitting section Ai and a first light receiving operation of the light receiving section Ci, and a second light emitting operation of the light emitting section Ai and a second light receiving operation of the light receiving section Ci is the unit time u×3 (1.5 ms). In the same manner as the first operation pattern 801, in the second operation pattern 802 as well, a period after the first light emitting operation of the light emitting section Ai and the first light receiving operation of the light receiving section Ci are completed until the second light emitting operation of the light emitting section Ai and the second light receiving operation of the light receiving section Ci are started corresponds to a light non-emitting period of the light emitting section Ai.

As described above, in the distance measurement apparatus 1, the period after the first light emitting operation of the light emitting section Ai and the first light receiving operation of the light receiving section Ci are completed until the second light emitting operation of the light emitting section Ai and the second light receiving operation of the light receiving section Ci are started is a period that can be allocated as a cooling period of the light emitting section Ai. That is, in the second operation pattern 802, the period of the unit time u×3 (1.5 ms) can be allocated as the cooling period of the light emitting section Ai.

In this manner, in the second operation pattern 802, the period (unit time u×3, 1.5 ms) that can be allocated as the cooling period of the light emitting section Ai is smaller than the period (unit time u×12, 6.0 ms) that can be allocated as the cooling period of the light emitting section Ai in the first operation pattern 801.

As described above, the distance measurement apparatus 1 according to the present exemplary embodiment operates according to any one of the first operation pattern 801 and the second operation pattern 802 in which the number of other light emitting sections 41 having the light emitting period to be included in the light non-emitting period of the light emitting section 41 differs, depending on the amount of light emitted from the light emitting section 41.

More specifically, in a case where the amount of light emitted from the light emitting section 41 is equal to or more than a predetermined reference value, the distance measurement apparatus 1 according to the present exemplary embodiment operates according to the first operation pattern 801 in which the number of other light emitting sections 41 having the light emitting period included in the light non-emitting period of the light emitting section 41 is large as compared with the second operation pattern 802. In this example, the reference value of the amount of light emitted from the light emitting section 41 is set such that the cooling period of the light emitting section 41 required to reduce an influence of heat generation associated with light emission of the VCSEL can be 1.5 ms (=unit time u (500 μs)×3) with the amount of light in the light emitting section 41.

In addition, in a case where the amount of light emitted from the light emitting section 41 is less than the reference value, the distance measurement apparatus 1 operates according to the second operation pattern 802 in which the number of other light emitting sections 41 having the light emitting period included in the light non-emitting period of the light emitting section 41 is small as compared with the first operation pattern 801.

As described above, in the first operation pattern 801, an interval (6.0 ms) between the first light emitting operation of the light emitting section Ai and the first light receiving operation of the light receiving section Ci, and the second light emitting operation of the light emitting section Ai and the second light receiving operation of the light receiving section Ci is larger than the interval (1.5 ms) in the second operation pattern 802. As a result, in a case where the amount of light emitted from the light emitting section 41 is equal to or more than the reference value, the distance measurement apparatus 1 operates according to the first operation pattern 801. Therefore, as compared with a case of the operation according to the second operation pattern 802, a period that can be allocated as the cooling period of each light emitting section Ai becomes larger. In this example, as the cooling period H3, a period up to the unit time u×12 (6.0 ms) can be allocated. Accordingly, with the distance measurement apparatus 1, even in a case where a large amount of light is emitted from the light emitting section 41 and a large amount of heat generated by the light emission of the VCSEL, each light emitting section 41 can be cooled up to a temperature at which the influence of the heat generation is reduced.

As described above, in the first operation pattern 801, the time (25.5 ms) until the scheduled number of light emitting periods in all the light emitting sections 41 are completed is smaller than the time (31.5 ms) in the second operation pattern 802.

Further, in the first operation pattern 801, the time (26.0 ms) until the distance measurement of all the irradiation sections 61 is completed is smaller than the time (32.0 ms) in the second operation pattern 802. As a result, the distance measurement apparatus 1 operates according to the first operation pattern 801 in a case where the amount of light emitted from the light emitting section 41 is equal to or more than the reference value, and thus as compared with a case of the operation according to the second operation pattern 802, a time required for the control unit 8 to create one distance image 100 is reduced.

Meanwhile, in some cases, the distance measurement apparatus 1 continuously creates and arranges in time-series the distance images 100 illustrated in FIG. 5C to create a moving image (referred to as a “distance moving image”) illustrating a distance measurement result corresponding to the passage of time. By using such a distance moving image, for example, it is possible to track a change in distance (position) of the target object S which is a moving object with the passage of time, calculate a movement speed, monitor a movement pattern, and the like.

The distance moving image is created with one distance image 100 as one frame, and has a frame rate corresponding to the number of distance images 100 created per unit time. As described above, in the distance measurement apparatus that operates according to the first operation pattern 801, the time required to complete the distance measurement of all the irradiation sections 61 is 26.0 ms, so that a frame rate of a distance moving image is 38 frames per second (fps) at a maximum. On the other hand, in the distance measurement apparatus 1 that operates according to the second operation pattern 802, the time required to complete the distance measurement of all the irradiation sections 61 is 32.0 ms, so that the frame rate of the distance moving image is 31 fps at a maximum.

Thus, the distance measurement apparatus 1 operates according to the first operation pattern 801 in a case where the amount of light emitted from the light emitting section 41 is equal to or more than the reference value, and thus as compared with a case of the operation according to the second operation pattern 802, the distance measurement apparatus 1 can be used for tracking the target object S operating at a high speed.

On the other hand, the distance measurement apparatus 1 operates according to the second operation pattern 802 in a case where the amount of light emitted from the light emitting section 41 is less than the reference value, and thus as compared with a case of the operation according to the first operation pattern 801, the distance measurement interval becomes smaller. In addition, as described above, in the distance measurement apparatus 1 that operates according to the first operation pattern 801, the distance measurement interval is equivalent to 12 times of unit time (6.0 ms), whereas in the distance measurement apparatus 1 that operates according to the second operation pattern 802, the distance measurement interval is the unit time u×3 (1.5 ms).

Accordingly, in a case where the amount of light emitted from the light emitting section 41 is less than the reference value, the distance measurement apparatus 1 operates according to the second operation pattern 802, and thus as compared with a case of the operation according to the first operation pattern 801, an influence of motion artifacts can be reduced.

As described above, in the distance measurement apparatus 1 according to the present exemplary embodiment, as the amount of light emitted from the light emitting section 41 is increased, the number of other light emitting sections 41 (second light emitting section) having the light emitting period included in the light non-emitting period of the light emitting section 41 (first light emitting section) is increased. In other words, in the distance measurement apparatus 1, as the amount of light emitted from the light emitting section 41 is decreased, the number of other light emitting sections 41 (second light emitting section) having the light emitting period included in the light non-emitting period of the light emitting section 41 (first light emitting section) is decreased.

In the example described above, an operation pattern to be followed by the distance measurement apparatus 1 in a case where the amount of light emitted from the light emitting section 41 is less than the reference value is set according to the second operation pattern 802 in which the number of the second light emitting sections having the light emitting period included in the light non-emitting period of the first light emitting section is 2. Meanwhile, in a case where the cooling period of each light emitting section 41 required for reducing the influence of heat generation associated with light emission is short, in the operation pattern to be followed by the distance measurement apparatus 1, the number of second light emitting sections having the light emitting period included in the light non-emitting period of the first light emitting section may be zero. In other words, in the operation pattern to be followed by the distance measurement apparatus 1, the light emitting period of the second light emitting section may not be included in the light non-emitting period of the first light emitting section.

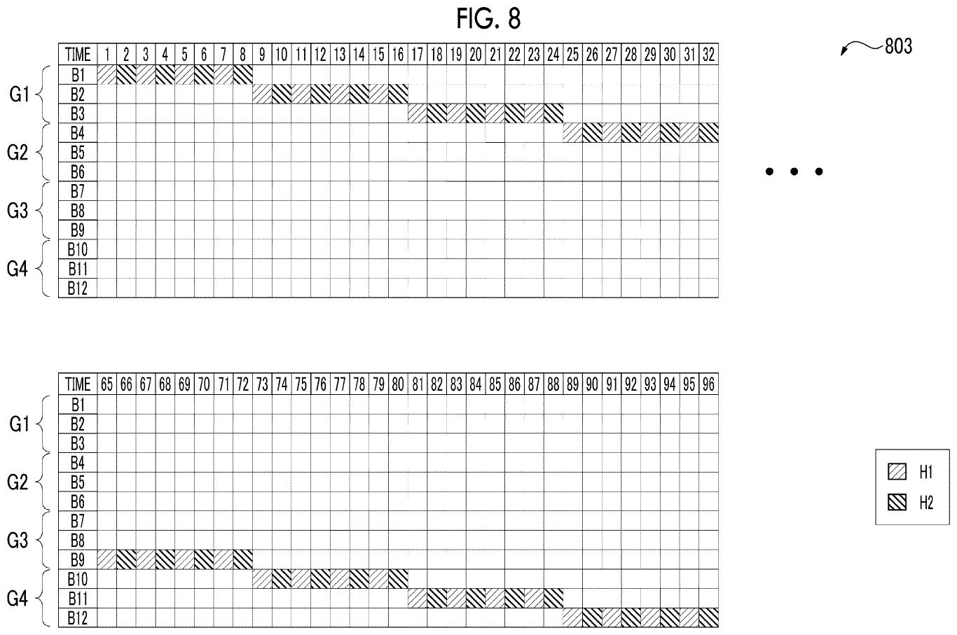

FIG. 8 is a diagram illustrating a third operation pattern 803 of the distance measurement apparatus 1 to which the present exemplary embodiment is applied.

In the third operation pattern 803, after an operation related to distance measurement of a certain irradiation section Bi is completed, an operation related to distance measurement of the next irradiation section Bj (j=i+1) is started.

More specifically, in the time u=1 of the third operation pattern 803, a light emitting operation in the light emitting section A1 corresponding to the irradiation section B1 and a light receiving operation at the first phase difference φ=0 degrees in the corresponding light receiving section C1 are performed. Next, in the time u=2, the control unit 8 performs a read operation on the light receiving section C1. In the time u=3, the light emitting operation in the light emitting section A1 and the light receiving operation at the second phase difference φ=0 degrees in the light receiving section C1 are performed. Next, in the time u=4, the control unit 8 performs the read operation on the light receiving section C1, in the same manner as in the time u=2. In the same manner, in the time u=5 to 6, the light emitting operation in the light emitting section A1, the light receiving operation in the light receiving section C1 at the first phase difference φ=180 degrees, and the read operation by the control unit 8 are performed. Further, in the same manner, in the time u=7 to 8, the light emitting operation in the light emitting section A1, the light receiving operation at the second phase difference φ=180 degrees in the light receiving section C1, and the read operation by the control unit 8 are performed. Accordingly, the operation related to the distance measurement of the irradiation section B1 is completed. Subsequent operations related to distance measurement in the irradiation sections B2 to B12 are also performed in the same manner as the operations related to the distance measurement in the irradiation section B1. In a case where the control unit 8 performs the fourth read operation on the light receiving section C12 corresponding to the last irradiation section B12 in the time u=96, the distance measurement of all the irradiation sections 61 (B1 to B12) is completed.

In this manner, in the third operation pattern 803, after the operation related to the distance measurement of the irradiation section Bi is completed, the operation related to the distance measurement of the next irradiation section Bj (j=i+1) is repeatedly started. By completing the operation related to the distance measurement of the last irradiation section B12, the distance measurement of all the irradiation sections 61 is completed, and the data necessary for creating the distance image 100 by the control unit 8 is prepared. As illustrated in FIG. 8, in the third operation pattern 803, a time until the distance measurement of all the irradiation sections 61 is completed is the unit time u×96 (=48.0 ms).

Further, in the third operation pattern 803, after one light emitting period in the light emitting section Ai, a light emitting period of another light emitting section Aj (j=i+1) is provided. As illustrated in FIG. 8, in the third operation pattern 803, a time until the scheduled number of four light emitting periods in all the light emitting sections 41 are completed is the unit time u×95 (=47.5 ms).

Further, in the third operation pattern 803, an interval between a first light emitting operation of the light emitting section Ai and a first light receiving operation of the light receiving section Ci, and a second light emitting operation of the light emitting section Ai and a second light receiving operation of the light receiving section Ci is the unit time u×1 (0.5 ms). In the same manner as the first operation pattern 801 and the second operation pattern 802, in the third operation pattern 803 as well, a period after the first light emitting operation of the light emitting section Ai and the first light receiving operation of the light receiving section Ci are completed until the second light emitting operation of the light emitting section Ai and the second light receiving operation of the light receiving section Ci are started corresponds to a light non-emitting period of the light emitting section Ai.

As described above, in the distance measurement apparatus 1, the period after the first light emitting operation of the light emitting section Ai and the first light receiving operation of the light receiving section Ci are completed until the second light emitting operation of the light emitting section Ai and the second light receiving operation of the light receiving section Ci are started is a period that can be allocated as a cooling period of the light emitting section Ai. That is, in the third operation pattern 803, the period of the unit time u×1 (0.5 ms) can be allocated as the cooling period of the light emitting section Ai.

Thus, in the present exemplary embodiment, for example, in a case where the amount of light emitted from the light emitting section 41 is the amount of light in a case where a cooling period of a light emitting section required for reducing the influence of heat generation is 0.5 ms (=unit time u×1), the distance measurement apparatus 1 preferably operates according to the third operation pattern 803.

The distance measurement apparatus 1 operates according to the third operation pattern 803, and thus the distance measurement interval becomes smaller as compared with a case of the operation according to the first operation pattern 801 and the second operation pattern 802. In addition, as described above, in the distance measurement apparatus 1 that operates according to the first operation pattern 801, the distance measurement interval is 12 times of unit time (6.0 ms), and in the distance measurement apparatus 1 operates according to the second operation pattern 802, the distance measurement interval is 3 times of unit time (1.5 ms), whereas in the distance measurement apparatus 1 that operates according to the third operation pattern 803, the distance measurement interval is 1 time of unit time (0.5 ms).

Accordingly, in the distance measurement apparatus 1, by operating according to the third operation pattern 803, the influence of the motion artifacts can be further reduced, as compared with a case of the operation according to the first operation pattern 801 and the second operation pattern 802.

In the distance measurement apparatus 1 according to the present exemplary embodiment, the amount of light emitted from the light emitting section 41 is set by, for example, a user who operates the distance measurement apparatus 1, in some cases. The control unit 8 calculates a cooling period of each light emitting section 41 required for reducing the influence of heat generation associated with light emission, based on the amount of light set by the user. The control unit 8 selects an operation pattern to be followed by the distance measurement apparatus 1 based on the calculated cooling period of each light emitting section 41, and controls the operations of the light emitting unit 4 and the light receiving unit 5 of the optical device 3.

In the distance measurement apparatus 1, for example, the amount of light emitted from the light emitting section 41 may be acquired based on a detection result by a light amount sensor or the like that detects the amount of light emitted from the light emitting section 41.

Further, transition of a temperature of the light emitting unit 4 after the light emitting operation is performed differs depending on a temperature of an environment in which the light emitting unit 4 is installed, and in some cases, the cooling period of each light emitting section 41 required to reduce the influence of heat generation associated with the light emission differs. For example, since in a case where the light emitting unit 4 is installed in a low-temperature environment, the temperature of the light emitting unit 4 drops faster after the light emitting operation is performed, as compared with a case where the light emitting unit 4 is installed in a high-temperature environment, the cooling period of each light emitting section 41 required to reduce the conditions is likely to be reduced. Therefore, the control unit 8 may calculate the cooling period of each light emitting section 41 required for reducing the influence of heat generation associated with the light emission, based on the temperature of the environment and the temperature of the light emitting unit 4. For example, the control unit 8 may acquire the temperature of the environment measured by a temperature sensor or the like and the temperature of the light emitting unit 4, and calculate the cooling period according to the acquired temperature information. More specifically, for example, in a case where a difference between the temperature of the environment and the temperature of the light emitting unit 4 is large, the control unit 8 may decrease the cooling period, and in a case where the difference between the temperature of the environment and the temperature of the light emitting unit 4 is small, the control unit 8 may increase the cooling period.

Further, in the distance measurement apparatus 1, after performing a part or all of an operation related to distance measurement according to a predetermined operation pattern, an operation pattern to be followed by the distance measurement apparatus 1 may be set based on a result obtained by the distance measurement. In this case, the distance measurement result is an example of an index that is changed due to heat generation in the light emitting section 41.

For example, the distance measurement apparatus 1 calculates a cooling period of each light emitting section 41 required to reduce the influence of heat generation associated with light emission, based on a state of the distance image 100 (see FIG. 5C) obtained as the distance measurement result, and changes an operation pattern to be followed by the distance measurement apparatus 1. Specifically, in a case where it is checked that distance measurement accuracy is decreased such that the image S′ is illustrated in a shape different from the actual target object S in the obtained distance image 100, it is assumed that the cooling period of each light emitting section 41 is insufficient, and the distance measurement apparatus 1 may change the operation pattern to be followed to an operation pattern capable of securing the larger cooling period.

### First Aspect of Switching of Operation Pattern Depending on Situation of Target Object at Irradiation Surface 60

Next, a first aspect in which the distance measurement apparatus 1 switches an operation pattern according to a situation of a target object existing at the irradiation surface 60 will be described. Here, as the situation of the target object existing at the irradiation surface 60, an aspect of switching an operation pattern according to the relative movement amount of the target object at the irradiation surface 60 in a case where the target object is a moving object will be described.

In the present exemplary embodiment, the relative movement amount of the target object means the movement amount of the target object per unit time at the irradiation surface 60. In addition, even in a case where movement speeds of the target objects are equal, the closer the distance between the light emitting surface 40 and the irradiation surface 60 at which the target object exists, the larger the relative movement amount of the target object. The distance measurement apparatus 1 according to the present exemplary embodiment acquires, for example, the relative movement amount of the target object based on an infrared image captured by the imaging unit 9.

In the distance measurement apparatus 1, as the relative movement amount of the target object is larger, the movement of the target object between a first light emitting operation of the light emitting section 41 and a first light receiving operation of the light receiving section 51 corresponding to a certain irradiation section 61, and a second light emitting operation of the same light emitting section 41 and a second light receiving operation of the light receiving section 51 becomes larger, and an influence of motion artifacts is likely to occur.

Further, as described above, in the distance measurement apparatus 1, as an interval between the first light emitting operation of the light emitting section 41 and the first light receiving operation of the light receiving section 51 corresponding to the certain irradiation section 61, and the second light emitting operation of the same light emitting section 41 and the second light receiving operation of the light receiving section 51 is increased, the movement of the target object S during that interval is increased, and the influence of the motion artifacts is likely to occur.

In the distance measurement apparatus 1 according to the present exemplary embodiment, as the relative movement amount of the target object at the irradiation surface 60 is increased, the number of other light emitting sections 41 having a light emitting period to be included in a light non-emitting period of the light emitting section 41 is set to be decreased.

As described above, in the operation pattern of the distance measurement apparatus 1, a period after the first light emitting operation of the light emitting section 41 and the first light receiving operation of the light receiving section 51 corresponding to the certain irradiation section 61 are completed until the second light emitting operation of the same light emitting section 41 and the second light receiving operation of the light receiving section 51 are started corresponds to the light non-emitting period. In the distance measurement apparatus 1, as the relative movement amount of the target object at the irradiation surface 60 is increased, the number of other light emitting sections 41 having the light emitting period to be included in the light non-emitting period of the light emitting section 41 is set to be decreased, and thus the period after the first light emitting operation of the light emitting section 41 and the first light receiving operation of the light receiving section 51 corresponding to the certain irradiation section 61 are completed until the second light emitting operation of the same light emitting section 41 and the second light receiving operation of the light receiving section 51 are started is reduced. Accordingly, it is possible to decrease the movement of the target object between the first light emitting operation of the light emitting section 41 and the first light receiving operation of the light receiving section 51 corresponding to the certain irradiation section 61, and the second light emitting operation of the same light emitting section 41 and the second light receiving operation of the light receiving section 51, and it is possible to reduce the influence of the motion artifacts.

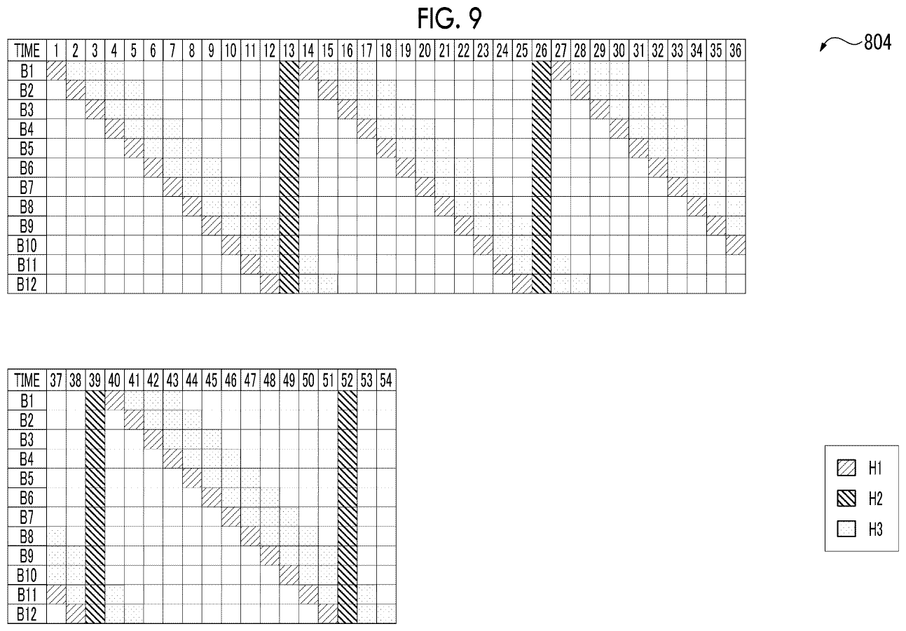

FIG. 9 is a diagram illustrating a fourth operation pattern 804 of the distance measurement apparatus 1 to which the present exemplary embodiment is applied.

In this example, in the distance measurement apparatus 1, depending on the relative movement amount of the target object at the irradiation surface 60, a light emitting operation by each light emitting section 41, a light receiving operation by each light receiving section 51, and a read operation on each light receiving section 51 are performed according to the second operation pattern 802 illustrated in FIG. 7 or the fourth operation pattern 804 illustrated in FIG. 9.

Here, in any of the second operation pattern 802 and the fourth operation pattern 804, a case in which a predetermined cooling period for reducing an influence of heat generation associated with light emission is 1.5 ms (3 times of unit time) will be described as an example.

First, the fourth operation pattern 804 illustrated in FIG. 9 will be described.

The fourth operation pattern 804 has the same manner as the first operation pattern 801 illustrated in FIG. 6, except that a cooling period in each light emitting section 41 is 3 times of unit time.

Thus, in the fourth operation pattern 804, an interval (distance measurement interval) between a first light emitting operation of the light emitting section Ai and a first light receiving operation of the light receiving section Ci, and a second light emitting operation of the light emitting section Ai and a second light receiving operation of the light receiving section Ci is the unit time u×12 (6.0 ms). In the fourth operation pattern 804, a period after the first light emitting operation of the light emitting section Ai and the first light receiving operation of the light receiving section Ci are completed until the second light emitting operation of the light emitting section Ai and the second light receiving operation of the light receiving section Ci are started corresponds to a light non-emitting period of the light emitting section Ai.

Further, in the fourth operation pattern 804, a time until distance measurement of all the irradiation sections 61 is completed (52 times of unit time=26.0 ms), a time until the scheduled number of four light emitting periods in all the light emitting sections 41 are completed (51 times of unit time=25.5 ms), and a frame rate of a distance moving image (38 fps at a maximum) are equal to the first operation pattern 801.

In addition, in the second operation pattern 802, as described above, the interval (distance measurement interval) between the first light emitting operation of the light emitting section Ai and the first light receiving operation of the light receiving section Ci, and the second light emitting operation of the light emitting section Ai and the second light receiving operation of the light receiving section Ci is the unit time u×3 (1.5 ms).

In a case where the relative movement amount of the target object at the irradiation surface 60 is equal to or more than a predetermined reference value, the distance measurement apparatus 1 according to the present exemplary embodiment operates according to the second operation pattern 802 in which the number of other light emitting sections 41 having the light emitting period included in the light non-emitting period of the light emitting section 41 is small as compared with the fourth operation pattern 804.

In the second operation pattern 802, the interval (1.5 ms) between the first light emitting operation of the light emitting section Ai and the first light receiving operation of the light receiving section Ci, and the second light emitting operation of the light emitting section Ai and the second light receiving operation of the light receiving section Ci is smaller than the interval (6.0 ms) in the fourth operation pattern 804.

Accordingly, in a case where the relative movement amount of the target object at the irradiation surface 60 is equal to or more than the predetermined reference value, the distance measurement apparatus 1 operates according to the second operation pattern 802, and thus an influence of motion artifacts can be reduced as compared with a case of the operation according to the fourth operation pattern 804.

On the other hand, in a case where the relative movement amount of the target object at the irradiation surface 60 is less than the predetermined reference value, the distance measurement apparatus 1 according to the present exemplary embodiment operates according to the fourth operation pattern 804 in which the number of other light emitting sections 41 having the light emitting period included in the light non-emitting period of the light emitting section 41 is large as compared with the second operation pattern 802. In addition, a case where the relative movement amount of the target object at the irradiation surface 60 is less than the predetermined reference value also includes a case where the relative movement amount of the target object at the irradiation surface 60 is 0, in other words, a case where there is no moving object at the irradiation surface 60.

In the fourth operation pattern 804, a time (25.5 ms) until the scheduled number of light emitting periods in all the light emitting sections 41 are completed is smaller than the time (31.5 ms) in the second operation pattern 802. Further, in the fourth operation pattern 804, a time (26.0 ms) until the distance measurement of all the irradiation sections 61 is completed is smaller than the time (32.0 ms) in the second operation pattern 802.

Accordingly, the distance measurement apparatus 1 operates according to the fourth operation pattern 804 in a case where the relative movement amount of the target object at the irradiation surface 60 is less than the predetermined reference value, and thus a time required for the control unit 8 to create one distance image 100 is reduced as compared with a case of the operation according to the second operation pattern 802.

Further, in the fourth operation pattern 804, a frame rate of the distance moving image (38 fps at a maximum) is larger than a frame rate of the second operation pattern 802 (31 fps at a maximum).

Accordingly, the distance measurement apparatus 1 operates according to the fourth operation pattern 804 in a case where the relative movement amount of the target object at the irradiation surface 60 is less than the predetermined reference value, and thus the distance measurement apparatus 1 can be used for tracking the target object S that operates at a higher speed as compared with a case of the operation according to the second operation pattern 802.

### Second Aspect of Switching of Operation Pattern Depending on Situation of Target Object at Irradiation Surface 60

Next, a second aspect in which the distance measurement apparatus 1 switches an operation pattern according to a situation of a target object existing at the irradiation surface 60 will be described. Here, as the situation of the target object existing at the irradiation surface 60, an aspect of switching an operation pattern according to a movement direction of the target object at the irradiation surface 60 in a case where the target object is a moving object will be described.

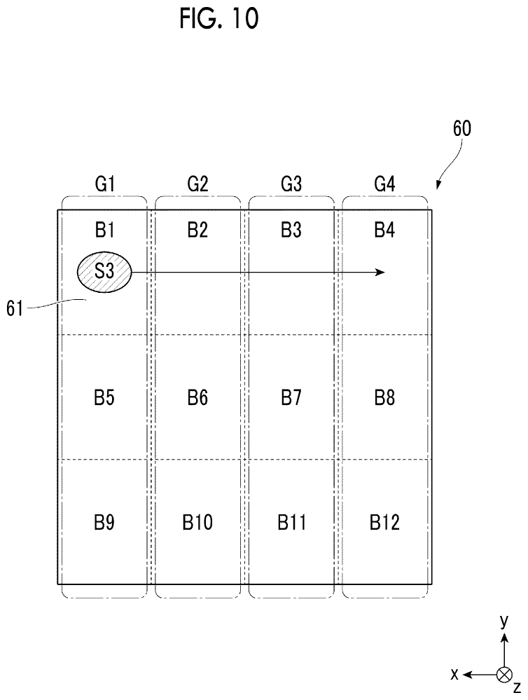

FIG. 10 is a diagram illustrating a situation of a target object S3 existing at the irradiation surface 60 and an example of a method of grouping the irradiation sections 61 in a fifth operation pattern 805 to be described below.

In the example illustrated in FIG. 10, the target object S3 exists at a position separated from the distance measurement apparatus 1 by a certain distance. The target object S3 in this example moves in the −x direction from the irradiation section B1 of the irradiation surface 60. In addition, the target object S3 moves in the −x direction in order of the irradiation sections B1, B2, B3, and B4, at the irradiation surface 60. The distance measurement apparatus 1 according to the present exemplary embodiment acquires a movement direction of the target object S3 at the irradiation surface 60, based on, for example, an infrared image captured by the imaging unit 9.

Meanwhile, in the distance measurement apparatus 1, in a case where the irradiation sections 61, the corresponding light emitting sections 41, and the corresponding light receiving sections 51 are divided into a plurality of groups and an operation of the distance measurement apparatus 1 is determined based on the grouping, depending on a relationship between a method of the grouping and the movement direction of the target object S3 at the irradiation surface 60, accuracy of the distance measurement may deteriorate such as a distortion occurring in the obtained distance image 100 (refer to FIG. 5C).

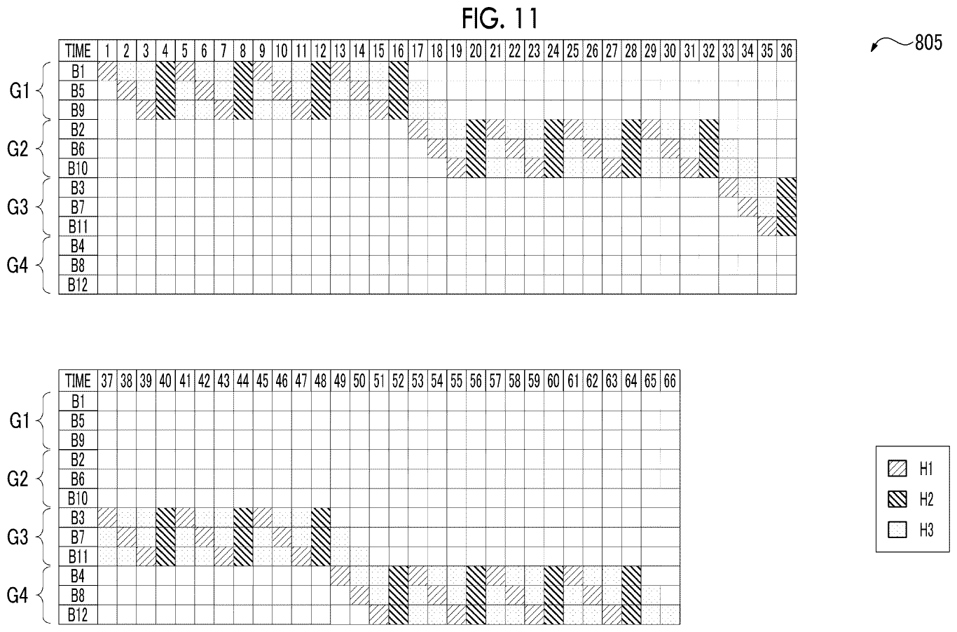

FIG. 11 is a diagram illustrating the fifth operation pattern 805 of the distance measurement apparatus 1 to which the present exemplary embodiment is applied.

In the same manner as the second operation pattern 802 described above, in the fifth operation pattern 805, the irradiation sections 61, the corresponding light emitting sections 41, and the corresponding light receiving sections 51 are divided into a plurality of groups, and an operation of the distance measurement apparatus 1 is defined based on this grouping.

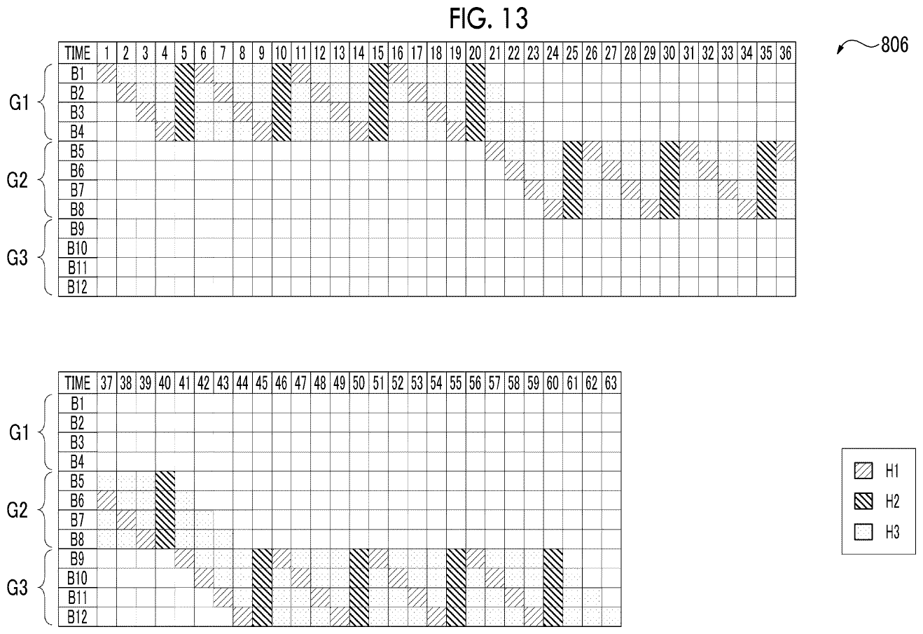

Here, in any of the fifth operation pattern 805 illustrated in FIG. 11 and a sixth operation pattern 806 illustrated in FIG. 13 to be described below, a case where a predetermined cooling period for reducing an influence of heat generation associated with light emission is set to 1.5 ms (3 times of unit time) will be described as an example.

As illustrated in FIGS. 10 and 11, in the fifth operation pattern 805, the irradiation sections B1, B5, and B9 belong to the group G1, the irradiation sections B2, B6, and B10 belong to the group G2, the irradiation sections B3, B7, and B11 belong to the group G3, and the irradiation sections B4, B8, and B12 belong to the group G4. In addition, in the fifth operation pattern 805, the three irradiation sections 61 arranged along the y-direction at the irradiation surface 60 belong to the same group G. Although details will be described below, in the fifth operation pattern 805, a direction in which the plurality of irradiation sections 61 belonging to the same group G are arranged is different from a movement direction of the target object S3 at the irradiation surface 60.

Each light emitting section Ai and each light receiving section Ci belong to the same group as the corresponding irradiation section Bi.

In the same manner as the second operation pattern 802, in the fifth operation pattern 805, after an operation related to distance measurement of the group Gi is completed, an operation related to distance measurement of the group Gj (j=i+1) is started. From the viewpoint of a light emitting operation, in a light non-emitting period of the light emitting section Ai belonging to the group Gi, a light emitting period of the light emitting section Aj (j≠i) belonging to the same group Gi is provided. After the scheduled number of four light emitting periods in the light emitting sections Ai and Aj belonging to the group Gi, a light emitting period of the light emitting section Ak (k≠i, j) belonging to the group Gj is provided. In this example, the light emitting section Ai is an example of a first light emitting section, the light emitting section Aj is an example of a second light emitting section, the group Gi is an example of one light emitting section group, and the group Gj is an example of another light emitting section group.

In addition, in the fifth operation pattern 805, in a case where the light emitting section A1 is set as a first light emitting section, the light emitting sections A5 and A9 having light emitting periods included in a light non-emitting period of the light emitting section A1 correspond to second light emitting sections. Further, in the fifth operation pattern 805, the second light emitting sections are arranged side by side in a direction different from the movement direction of the target object S3, with respect to the first light emitting section.

As illustrated in FIG. 11, in the fifth operation pattern 805, in the time u=1, the light emitting section A1 corresponding to the irradiation section B1 performs a light emitting operation, and the corresponding light receiving section C1 performs a light receiving operation at the first phase difference φ=0 degrees. Further, in the time u=2, the light emitting section A5 corresponding to the irradiation section B5 performs the light emitting operation, and the corresponding light receiving section C5 performs a light receiving operation. Further, in the time u=3, the light emitting section A9 corresponding to the irradiation section B9 performs the light emitting operation, and the corresponding light receiving section C9 performs the light receiving operation. In the time u=4, the control unit 8 performs a read operation for each of the light receiving sections C1, C5, and C9. Accordingly, the distance measurement apparatus 1 (control unit 8) acquires a result of the first light reception at the phase difference φ=0 degrees in the irradiation sections B1, B5, and B9 belonging to the group G1. In the same manner, in the time u=5 to 8, a result of second light reception at the phase difference φ=0 degrees is acquired, in the time u=9 to 12, a result of first light reception at the phase difference φ=180 degrees is obtained, and in the time u=13 to 16, a result of second light reception at the phase difference φ=180 degrees is acquired. In this manner, in the time u=1 to 16, four light emitting operations in the light emitting sections A1, A5, and A9 corresponding to the irradiation sections B1, B5, and B9 of the group G1, four light receiving operations in the corresponding light receiving sections C1, C5, and C9, and four read operations on the light receiving sections C1, C5, and C9 by the control unit 8 are performed. In other words, in the time u=16, the scheduled number of four light emitting operations, light receiving operations, and read operations for all the irradiation sections B1, B5, and B9 belonging to the group G1 are completed, and the operation related to the distance measurement of the group G1 is completed.

In a case where the operation related to the distance measurement of the group G1 is completed, in the time u=17, the light emitting section A2 corresponding to the irradiation section B2 performs a light emitting operation and the corresponding light receiving section C2 performs a first light receiving operation at the phase difference φ=0 degrees, and thus an operation related to distance measurement of the group G2 is started. Further, in the same manner as the group G1, the light emitting sections A2, A6, and A10 belonging to the group G2 perform the scheduled number of four light emitting operations, the light receiving sections C2, C6, and C10 perform the scheduled number of four light receiving operations, and the control unit 8 performs four read operations, and thus the operation related to the distance measurement of the group G2 is completed in the time u=32. In the same manner, an operation related to distance measurement of the group G3 is performed in the time u=33 to 48, and an operation related to distance measurement of the group G4 is performed in the time u=49 to 64. Thus, in the second operation pattern 802, the distance measurement of all the irradiation sections 61 (B1 to B12) is completed.

In this manner, in the fifth operation pattern 805, by performing the fourth read operation on the last group G4, the distance measurement of all the irradiation sections 61 is completed, and thus data necessary for creating the distance image 100 (see FIG. 5C) by the control unit 8 is prepared. As illustrated in FIG. 11, in the fifth operation pattern 805, a time until the distance measurement of all the irradiation sections 61 is completed is the unit time u×64 (=32.0 ms). In addition, in the fifth operation pattern 805, a time until the scheduled number of four light emitting periods in all the light emitting sections 41 are completed is the unit time u×63 (=31.5 ms).

Here, in the fifth operation pattern 805, a period after the light emitting operation of the light emitting section A1 corresponding to the irradiation section B1 belonging to the group G1 and the light receiving operation of the light receiving section C1 are completed until the light emitting operation of the light emitting section A2 corresponding to the irradiation section B2 belonging to the group G2, which is adjacent to the irradiation section B1 in the movement direction of the target object S3, and the light receiving operation of the light receiving section C2 are completed is the unit time u×16 (8.0 ms). In the same manner, in the fifth operation pattern 805, a period after the light emitting operation of the light emitting section A2 corresponding to the irradiation section B2 belonging to the group G2 and the light receiving operation of the light receiving section C2 are completed until the light emitting operation of the light emitting section A3 corresponding to the irradiation section B3 belonging to the group G3 and the light receiving operation of the light receiving section C3 are completed is the unit time u×16 (8.0 ms). In the same manner, in the fifth operation pattern 805, a period after the light emitting operation of the light emitting section A3 corresponding to the irradiation section B3 belonging to the group G3 and the light receiving operation of the light receiving section C3 are completed until the light emitting operation of the light emitting section A4 corresponding to the irradiation section B4 belonging to the group G4 and the light receiving operation of the light receiving section C4 are completed is the unit time u×16 (8.0 ms).

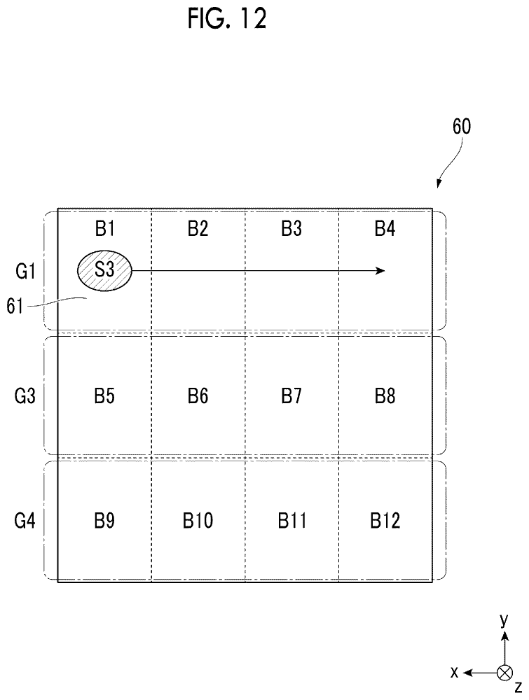

FIG. 12 is a diagram illustrating a situation of the target object S3 existing at the irradiation surface 60 and a method of grouping the irradiation sections 61 in the sixth operation pattern 806.

FIG. 13 is a diagram illustrating the sixth operation pattern 806 of the distance measurement apparatus 1 to which the present exemplary embodiment is applied.

As illustrated in FIGS. 12 and 13, in the sixth operation pattern 806, the irradiation sections B1 to B4 belong to the group G1, the irradiation sections B5 to B8 belong to the group G2, and the irradiation sections B9 to B12 belong to the group G3. In addition, in the sixth operation pattern 806, the four irradiation sections 61 arranged along the x-direction at the irradiation surface 60 belong to the same group G. Although details will be described below, in the sixth operation pattern 806, the plurality of irradiation sections 61 belonging to the same group G are arranged side by side in a movement direction of the target object S3 at the irradiation surface 60.

Each light emitting section Ai and each light receiving section Ci belong to the same group as the corresponding irradiation section Bi.

In the same manner as the second operation pattern 802, in the sixth operation pattern 806, after an operation related to distance measurement of the group Gi is completed, an operation related to distance measurement of the group Gj (j=i+1) is started. From the viewpoint of a light emitting operation, in a light non-emitting period of the light emitting section Ai belonging to the group Gi, a light emitting period of the light emitting section Aj (j≠i) belonging to the same group Gi is provided. After the scheduled number of four light emitting periods in the light emitting sections Ai and Aj belonging to the group Gi, a light emitting period of the light emitting section Ak (k≠i, j) belonging to the group Gj is provided. In this example, the light emitting section Ai is an example of a first light emitting section, the light emitting section Aj is an example of a second light emitting section, the group Gi is an example of one light emitting section group, and the group Gj is an example of another light emitting section group. In addition, in the sixth operation pattern 806, in a case where the light emitting section A1 is set as a first light emitting section, the light emitting sections A2 to A4 having light emitting periods in a light non-emitting period of the light emitting section A1 correspond to second light emitting sections. Further, in the fifth operation pattern 805, the second light emitting sections are arranged side by side in the movement direction of the target object S3 with respect to the first light emitting section.

As illustrated in FIG. 13, in the sixth operation pattern 806, an operation of the distance measurement apparatus 1 in the time u=1 to 3 has the same manner as the operation of the second operation pattern 802. In the time u=4, the light emitting section A4 corresponding to the irradiation section B4 performs a light emitting operation, and the corresponding light receiving section C4 performs a light receiving operation. In the time u=5, the control unit 8 performs a read operation for each of the light receiving sections C1 to C4. Accordingly, the distance measurement apparatus 1 (control unit 8) acquires a result of the light reception at the first phase difference φ=0 degrees in the irradiation sections B1 to B4 belonging to the group G1. In the same manner, in the time u=6 to 10, a result of the second light reception at the phase difference φ=0 degrees is acquired, in the time u=11 to 15, a result of the first light reception at the phase difference φ=180 degrees is acquired, and in the time u=16 to 20, a result of the second light reception at the phase difference φ=180 degrees is acquired. In this manner, in the time u=1 to 20, four light emitting operations in the light emitting sections A1 to A4 corresponding to the irradiation sections B1 to B4 of the group G1, four light receiving operations in the corresponding light receiving sections C1 to C4, and four read operations on the light receiving sections C1 to C4 by the control unit 8 are performed. Further, after the light emitting operations of the light emitting sections A1 to A4, the cooling periods for 4 times of unit time including the read operation period are secured.

After that, an operation related to distance measurement is performed in the same manner on the other groups G2 and G3.

In this manner, in the sixth operation pattern 806, by performing the fourth read operation on the last group G3, the distance measurement of all the irradiation sections 61 is completed, and thus data necessary for creating the distance image 100 (see FIG. 5C) by the control unit 8 is prepared. As illustrated in FIG. 13, in the sixth operation pattern 806, a time until the distance measurement of all the irradiation sections 61 is completed is the unit time u×60 (=30.0 ms). In addition, in the sixth operation pattern 806, a time until the scheduled number of four light emitting periods in all the light emitting sections 41 are completed is the unit time u×59 (=29.5 ms).

Here, in the sixth operation pattern 806, a period after the light emitting operation of the light emitting section A1 corresponding to the irradiation section B1 belonging to the group G1 and the light receiving operation of the light receiving section C1 are completed until the light emitting operation of the light emitting section A2 corresponding to the irradiation section B2 belonging to the group G1, which is adjacent to the irradiation section B1 in the movement direction of the target object S3, and the light receiving operation of the light receiving section C2 are completed is the unit time u×1 (0.5 ms). In the same manner, in the sixth operation pattern 806, a period after the light emitting operation of the light emitting section A2 corresponding to the irradiation section B2 and the light receiving operation of the light receiving section C2 are completed until the light emitting operation of the light emitting section A3 corresponding to the irradiation section B3 and the light receiving operation of the light receiving section C3 are completed is the unit time u×1 (0.5 ms). In the same manner, in the sixth operation pattern 806, a period after the light emitting operation of the light emitting section A3 corresponding to the irradiation section B3 and the light receiving operation of the light receiving section C3 are completed until the light emitting operation of the light emitting section A4 corresponding to the irradiation section B4 and the light receiving operation of the light receiving section C4 are completed is the unit time u×1 (0.5 ms).

Here, a case is considered in which the distance measurement apparatus 1 operates according to the fifth operation pattern 805 described above in a case where the target object S3 moves in the +x direction at the irradiation surface 60.

As described above, in the fifth operation pattern 805, an interval (16.0 ms) after the light emitting operation of the light emitting section 41 corresponding to a certain irradiation section 61 and the light receiving operation of the light receiving section 51 are completed until the light emitting operation of the light emitting section 41 corresponding to the irradiation section 61 adjacent to this irradiation section 61 in the −x direction and the light receiving operation of the light receiving section 51 are completed is larger than the interval (0.5 ms) in the sixth operation pattern 806.

In a case where a movement speed of the target object S3 at the irradiation surface 60 is excessively high, in the distance measurement apparatus 1 that operates according to the fifth operation pattern 805, a distance traveled by the target object S3 after the light emitting operation of the light emitting section 41 corresponding to the certain irradiation section 61 and the light receiving operation of the light receiving section 51 are completed until the light emitting operation of the light emitting section 41 corresponding to the irradiation section 61 adjacent to this irradiation section 61 in the −x direction and the light receiving operation of the light receiving section 51 are completed becomes larger.

In this case, accuracy of distance measurement on the target object S3 may deteriorate such as a distortion occurring in the image of the target object S3 in the obtained distance image 100 (see FIG. 5C).

On the other hand, in a case where the target object S3 moves in the +x direction at the irradiation surface 60, the distance measurement apparatus 1 according to the present exemplary embodiment operates according to the sixth operation pattern 806.

In the sixth operation pattern 806, an interval (0.5 ms) after the light emitting operation of the light emitting section 41 corresponding to the certain irradiation section 61 and the light receiving operation of the light receiving section 51 are completed until the light emitting operation of the light emitting section 41 corresponding to the irradiation section 61 adjacent to this irradiation section 61 in the −x direction and the light receiving operation of the light receiving section 51 are completed is smaller than the interval (16.0 ms) in the fifth operation pattern 805.

Accordingly, in the distance measurement apparatus 1, even in a case where the movement speed of the target object S3 at the irradiation surface 60 is high, the distance traveled by the target object S3 after the light emitting operation of the light emitting section 41 corresponding to the certain irradiation section 61 and the light receiving operation of the light receiving section 51 are completed until the light emitting operation of the light emitting section 41 corresponding to the irradiation section 61 adjacent to this irradiation section 61 in the −x direction and the light receiving operation of the light receiving section 51 are completed becomes smaller, as compared with a case of the operation according to the fifth operation pattern 805.

As a result, in the obtained distance image 100, a distortion is less likely to occur in the image of the target object S3, and the accuracy of distance measurement on the target object S3 is less likely to deteriorate.

In the example illustrated in FIG. 12, the movement direction of the target object S3 at the irradiation surface 60 and a direction in which the irradiation sections 61 (for example, the irradiation sections B1 to B4 of the group G1) included in each group G in which the plurality of irradiation sections 61 are grouped are arranged are the same direction, and the directions may not be completely identical. That is, a vector in a direction in which the irradiation sections 61 (for example, the irradiation sections B1 to B4 of the group G1) included in each group G in which the plurality of irradiation sections 61 are grouped are arranged may be included in the movement direction of the target object S3 at the irradiation surface 60.

Although not illustrated, the distance measurement apparatus 1 may operate according to the fifth operation pattern 805 illustrated in FIG. 11 in a case where, for example, the movement direction of the target object at the irradiation surface 60 is the ty direction. In this case, as compared with a case where the distance measurement apparatus 1 operates according to the sixth operation pattern 806, a distortion is less likely to occur in the image of the target object in the distance image 100, and the accuracy of distance measurement on the target object is less likely to deteriorate.

Here, the aspect in which the distance measurement apparatus 1 acquires the movement direction of the target object S3 existing at the irradiation surface 60 based on a captured image captured by the imaging unit 9, and follows an operation pattern according to the acquired movement direction of the target object S3 is described. Meanwhile, the exemplary embodiment is not limited to the aspect.

For example, in a case where the target object for distance measurement is set as an object having a predetermined movement direction or relative movement amount, such as an object transported by a belt conveyor, the distance measurement apparatus 1 may, for example, accept an input on the movement direction and relative movement amount of the target object from a user, and operate according to an operation pattern according to the received movement direction and relative movement amount of the target object.

### Third Aspect of Switching of Operation Pattern Depending on Situation of Target Object at Irradiation Surface 60

Meanwhile, in the second operation pattern 802, the fifth operation pattern 805, and the sixth operation pattern 806 described above, in a case where the irradiation sections 61, and the corresponding light emitting sections 41 and light receiving sections 51 are divided into a plurality of groups, the numbers of the irradiation sections 61, the light emitting sections 41, and the light receiving sections 51 belonging to each group are equal to each other. Meanwhile, the numbers of the irradiation sections 61, the light emitting sections 41, and the light receiving sections 51 belonging to each group may be different from each other.

Next, a third aspect in which the distance measurement apparatus 1 switches an operation pattern according to a situation of a target object existing at the irradiation surface 60 will be described. Here, as the situation of the target object existing at the irradiation surface 60, an aspect in which a method of dividing the plurality of irradiation sections 61 and the like into groups differs depending on a position at which the target object exists at the irradiation surface 60 will be described. The distance measurement apparatus 1 according to the present exemplary embodiment acquires the position of the target object at the irradiation surface 60, based on, for example, an infrared image captured by the imaging unit 9.

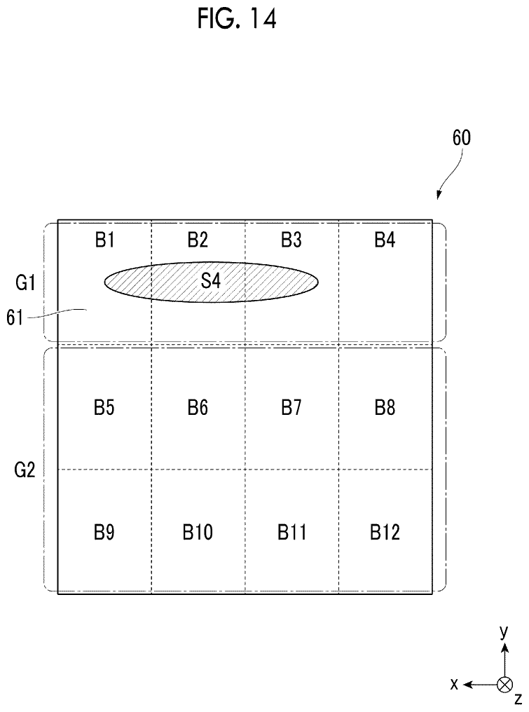

FIG. 14 is a diagram illustrating a situation of a target object S4 existing at the irradiation surface 60 and a method of grouping the irradiation sections 61 in a seventh operation pattern 807.

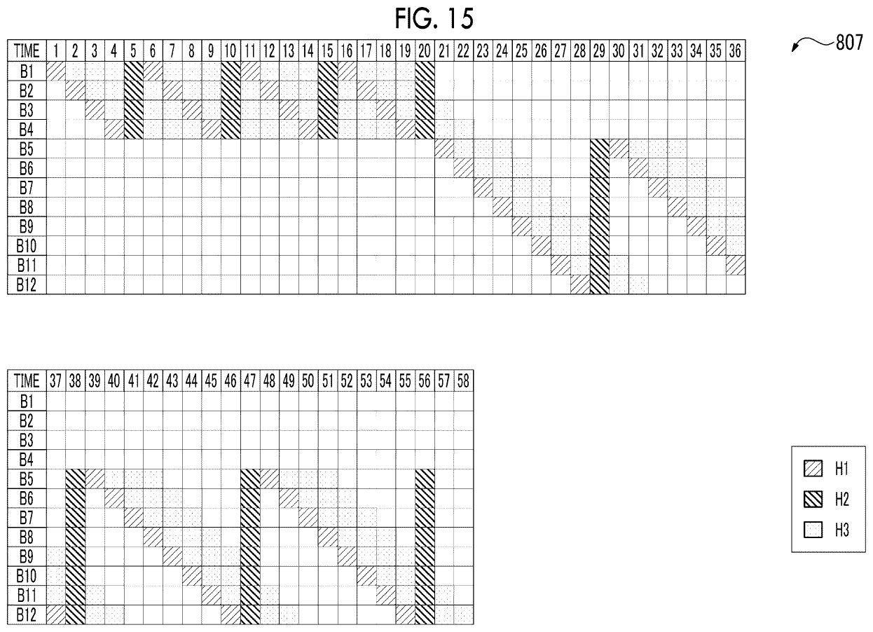

FIG. 15 is a diagram illustrating the seventh operation pattern 807 of the distance measurement apparatus 1 to which the present exemplary embodiment is applied.

Here, in the seventh operation pattern 807 illustrated in FIG. 15, a case where a predetermined cooling period for reducing an influence of heat generation associated with light emission is 1.5 ms (3 times of unit time) will be described as an example.

In the example illustrated in FIG. 14, at the irradiation surface 60, the target object S4, which is a stationary object that does not move, exists across the irradiation sections B1 to B3.

As illustrated in FIGS. 14 and 15, in the seventh operation pattern 807, the irradiation sections B1 to B4 belong to the group G1 and the irradiation sections B5 to B12 belong to the group G2. In this manner, in the seventh operation pattern 807, the number of irradiation sections 61 belonging to the group G in a case of the group G1 including the irradiation sections B1 to B3 in which the target object S4 exists at the irradiation surface 60 is larger than the number of irradiation sections 61 belonging to the group G in a case of the group G2 which does not include the irradiation sections B1 to B3 in which the target object S4 exists at the irradiation surface 60.

Each light emitting section Ai and each light receiving section Ci belong to the same group as the corresponding irradiation section Bi.

In the same manner as the second operation pattern 802, in the seventh operation pattern 807, after an operation related to distance measurement of the group Gi is completed, an operation related to distance measurement of the group Gj (j=i+1) is started. From the viewpoint of a light emitting operation, in a light non-emitting period of the light emitting section Ai belonging to the group Gi, a light emitting period of the light emitting section Aj (j≠i) belonging to the same group Gi is provided. After the scheduled number of four light emitting periods in the light emitting sections Ai and Aj belonging to the group Gi, a light emitting period of the light emitting section Ak (k≠i, j) belonging to the group Gj is provided. In this example, the light emitting section Ai is an example of a first light emitting section, the light emitting section Aj is an example of a second light emitting section, the group Gi is an example of one light emitting section group, and the group Gj is an example of another light emitting section group.

In addition, in the seventh operation pattern 807, in the group G1, in a case where the light emitting section A1 is set as a first light emitting section, the light emitting sections A2 to A4 having light emitting periods in a light non-emitting period of the light emitting section A1 correspond to second light emitting sections. In addition, in the seventh operation pattern 807, in the group G2, in a case where the light emitting section A5 is set as a first light emitting section, the light emitting sections A6 to A12 having light emitting periods in a light non-emitting period of the light emitting section A5 correspond to second light emitting sections. That is, in the seventh operation pattern 807, the numbers of second light emitting sections and positions of the second light emitting section with respect to the first light emitting section are different between the group G1 and the group G2, which are examples of a light emitting section group.

As illustrated in FIG. 15, in the seventh operation pattern 807, an operation of the distance measurement apparatus 1 in the time u=1 to 20 has the same manner as the operation of the sixth operation pattern 806. That is, in the time u=20, the distance measurement apparatus 1 (control unit 8) completes the scheduled number of four light emitting operations, light receiving operations, and read operations for all the irradiation sections B1 to B4 belonging to the group G1, and completes the operation related to the distance measurement of the group G1.

In a case where the operation related to the distance measurement of the group G1 is completed, in the time u=21, the light emitting section A5 corresponding to the irradiation section B5 performs a light emitting operation and the corresponding light receiving section C5 performs a first light receiving operation at the phase difference φ=0 degrees, and thus an operation related to distance measurement of the group G2 is started. Further, in the same manner as the group G1, the light emitting sections A5 to A12 belonging to the group G2 perform the scheduled number of four light emitting operations, the light receiving sections C5 to C12 perform the scheduled number of four light receiving operations, and the control unit 8 performs four read operations, and thus the operation related to the distance measurement of the group G2 is completed in the time u=56.

In this manner, in the seventh operation pattern 807, by performing the fourth read operation on the group G2, the distance measurement of all the irradiation sections 61 is completed, and thus data necessary for creating the distance image 100 (see FIG. 5C) by the control unit 8 is prepared. As illustrated in FIG. 15, in the seventh operation pattern 807, a time until the distance measurement of all the irradiation sections 61 is completed is the unit time u×56 (=28.0 ms). In addition, a time until the scheduled number of four light emitting periods in all the light emitting sections 41 are completed is the unit time u×55 (=27.5 ms).

In the seventh operation pattern 807, an interval between a first light emitting operation of the light emitting section Ai belonging to the group G1 and a first light receiving operation of the light receiving section Ci, and a second light emitting operation of the light emitting section Ai and a second light receiving operation of the light receiving section Ci is the unit time u×4 (2.0 ms).

Further, in the seventh operation pattern 807, an interval between a first light emitting operation of the light emitting section Aj (j≠i) belonging to the group G2 and a first light receiving operation of the light receiving section Cj, and a second light emitting operation of the light emitting section Aj and a second light receiving operation of the light receiving section Cj is the unit time u×8 (4.0 ms).

That is, in the seventh operation pattern 807, the interval of the group G1 between the first light emitting operation of the light emitting section 41 and the first light receiving operation of the light receiving section 51 corresponding to the irradiation section 61 belonging to the group G and the second light emitting operation of the same light emitting section 41 and the second light receiving operation of the light receiving section 51 is small as compared with the interval of the group G2.

As described above, in the distance measurement apparatus 1, as an interval between the first light emitting operation of the light emitting section 41 and the first light receiving operation of the light receiving section 51 corresponding to the certain irradiation section 61, and the second light emitting operation of the same light emitting section 41 and the second light receiving operation of the light receiving section 51 is decreased, an influence of motion artifacts is reduced.

In the present exemplary embodiment, the distance measurement apparatus 1 operates according to the seventh operation pattern 807, and thus, for example, the influence of the motion artifacts can be reduced as compared with a case where the interval between the first light emitting operation of the light emitting section 41 corresponding to the irradiation section 61 belonging to the group G1 and the first light receiving operation of the light receiving section 51, and the second light emitting operation of the same light emitting section 41 and the second light receiving operation of the light receiving section 51 is equal to the interval of the group G2.

Further, in the seventh operation pattern 807, the number of the irradiation sections 61, the light emitting sections 41, and the light receiving sections 51 included in a group to which the irradiation section 61 and the like in which the target object S4 does not exist belong is set to be larger than the number of the irradiation sections 61, the light emitting sections 41, and the light receiving sections 51 included in a group to which the irradiation section 61 and the like in which the target object S4 exists belong, and thus a time required for the control unit 8 to create one distance image 100 is reduced.

For example, the seventh operation pattern 807 will be compared with the sixth operation pattern 806 in which the numbers of the irradiation sections 61, the light emitting sections 41, and the light receiving sections 51 belonging to the groups G1 to G3 are equal to each other. In the seventh operation pattern 807, a time (27.5 ms) until the scheduled number of light emitting periods in all the light emitting sections 41 are completed is smaller than the time (29.5 ms) in the sixth operation pattern 806. Further, in the seventh operation pattern 807, the time (28.0 ms) until the distance measurement of all the irradiation sections 61 is completed is smaller than the time (30.0 ms) in the sixth operation pattern 806.

Further, in the seventh operation pattern 807, a frame rate of the distance moving image (35 fps at a maximum) is larger than a frame rate of the sixth operation pattern 806 (33 fps at a maximum).

Accordingly, in the distance measurement apparatus 1, the number of the irradiation sections 61, the light emitting sections 41, and the light receiving sections 51 included in the group to which the irradiation section 61 and the like in which the target object S4 does not exist belong is set to be large as compared with the group to which the irradiation section 61 and the like in which the target object S4 exists belong, and thus the distance measurement apparatus 1 can be used for tracking the target object S that operates at a higher speed as compared with a case of the operation according to the sixth operation pattern 806.

Regarding Operation Pattern in which Light Emitting Periods of Plurality of Light Emitting Sections Overlap with Each Other

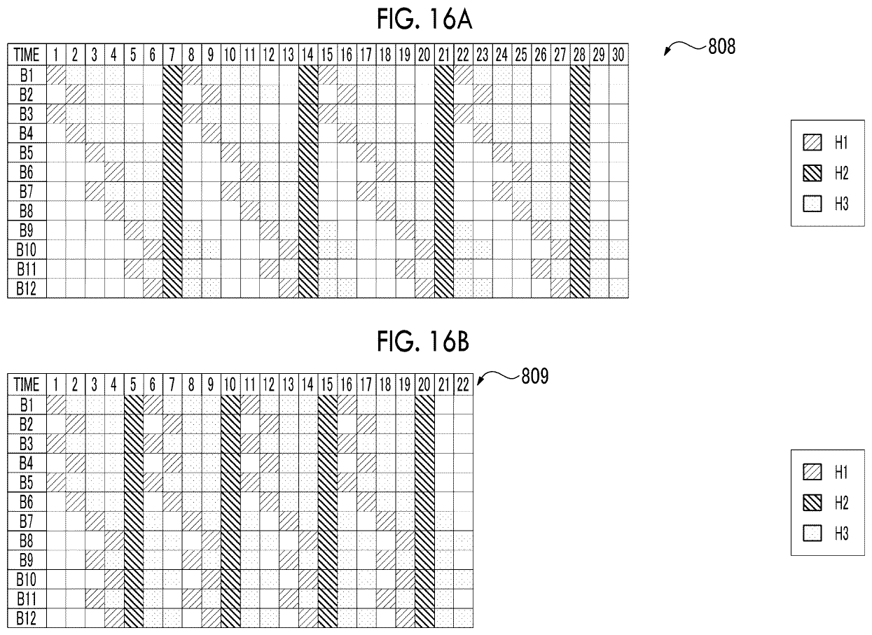

FIGS. 16A and 16B are diagrams illustrating an eighth operation pattern 808 and a ninth operation pattern 809 of the distance measurement apparatus 1 to which the present exemplary embodiment is applied.

In the first operation pattern 801 to the seventh operation pattern 807 described above, a case where the operation pattern is defined such that a light emitting period in one light emitting section Ai and a light emitting period in another light emitting section Aj (j≠i) do not overlap with each other is described as an example. On the other hand, in the eighth operation pattern 808 and the ninth operation pattern 809 illustrated in FIGS. 16A and 16B, a light emitting operation is allowed to be performed such that a light emitting period of a certain light emitting section Ai overlaps with a light emitting period of the light emitting section Ak (k≠i) which is not adjacent to the light emitting section Ai. In this example, the light emitting section Ai is an example of a first light emitting section, and the light emitting section Ak is an example of a third light emitting section.

In addition, in the eighth operation pattern 808, in a case where the light emitting section A1 is set as a first light emitting section, the light emitting section A3 which has a light emitting period overlapping with the light emitting section A1 and is not adjacent to the light emitting section A1 corresponds to a third light emitting section. Further, in the ninth operation pattern 809, in a case where the light emitting section A1 is set as a first light emitting section, the light emitting section A3 and the light emitting section A5 which have light emitting periods overlapping with the light emitting section A1 and are not adjacent to the light emitting section A1 correspond to third light emitting sections. That is, the numbers of third light emitting sections and the positions of the third light emitting section with respect to the first light emitting section are different between the eighth operation pattern 808 and the ninth operation pattern 809.

In the eighth operation pattern 808, in the time u=1, the light emitting section A1 corresponding to the irradiation section B1 performs a light emitting operation, and the corresponding light receiving section C1 performs a first light receiving operation at the phase difference φ=0 degrees. In the same manner, in the time u=1, in parallel, the light emitting section A3 corresponding to the irradiation section B3 performs the light emitting operation, and the corresponding light receiving section C3 performs the first light receiving operation at the phase difference φ=0 degrees. Further, in the time u=2, the light emitting section A2 corresponding to the irradiation section B2 performs the light emitting operation, and the corresponding light receiving section C2 performs a light receiving operation. In the same manner, in the time u=2, in parallel, the light emitting section A4 corresponding to the irradiation section B4 performs the light emitting operation, and the corresponding light receiving section C4 performs the light receiving operation. In the same manner, regarding a combination of the irradiation sections B5 and B7, a combination of the irradiation sections B6 and B8, a combination of the irradiation sections B9 and B11, and a combination of the irradiation sections B10 and B12, the light emitting operations of the corresponding light emitting sections 41 and the light receiving operations of the corresponding light receiving sections 51 are performed in parallel. Thus, in the eighth operation pattern 808, in a combination of the light emitting sections A1 and A3 that are not adjacent to each other, a combination of the light emitting sections A2 and A4, a combination of the light emitting sections A5 and A7, a combination of the light emitting sections A6 and A8, a combination of the light emitting sections A9 and A11, and a combination of the light emitting sections A10 and A12, the light emitting operations are performed at the same time u, and the light emitting periods overlap with each other. In the time u=7, the control unit 8 performs a read operation for each of the light receiving sections C1 to C12, thereby acquiring a result of the first light reception at the phase difference φ=0 degrees for all the irradiation sections 61. In the same manner, in the time u=8 to 14, a result of the second light reception at the phase difference φ=0 degrees is acquired, in the time u=15 to 21, a result of the first light reception at the phase difference φ=180 degrees is acquired, and in the time u=22 to 28, a result of the second light reception at the phase difference φ=180 degrees is acquired. Thus, in the eighth operation pattern 808, the distance measurement of all the irradiation sections 61 (B1 to B12) is completed.

As illustrated in FIG. 16A, in the eighth operation pattern 808, a time until the distance measurement of all the irradiation sections 61 is completed is the unit time u×28 (=14.0 ms). In addition, a time until the scheduled number of four light emitting periods in all the light emitting sections 41 are completed is the unit time u×27 (=13.5 ms). Further, a distance measurement interval in the eighth operation pattern 808 is 6 times of unit time (3.0 ms).

In addition, in the ninth operation pattern 809, in the time u=1, the light emitting section A1 corresponding to the irradiation section B1 performs a light emitting operation, and the corresponding light receiving section C1 performs a first light receiving operation at the phase difference φ=0 degrees. In the same manner, in the time u=1, in parallel, the light emitting section A3 corresponding to the irradiation section B3 performs the light emitting operation, and the corresponding light receiving section C3 performs the first light receiving operation at the phase difference φ=0 degrees. Further, in the same manner, in the time u=1, in parallel, the light emitting section A5 corresponding to the irradiation section B5 performs the light emitting operation, and the corresponding light receiving section C5 performs the first light receiving operation at the phase difference φ=0 degrees. Further, in the time u=2, the light emitting section A2 corresponding to the irradiation section B2 performs the light emitting operation, and the corresponding light receiving section C2 performs a light receiving operation. In the same manner, in the time u=2, in parallel, the light emitting section A4 corresponding to the irradiation section B4 performs the light emitting operation, and the corresponding light receiving section C4 performs the light receiving operation. Further, in the same manner, in the time u=2, in parallel, the light emitting section A6 corresponding to the irradiation section B6 performs the light emitting operation, and the corresponding light receiving section C6 performs the first light receiving operation at the phase difference φ=0 degrees. In the same manner, for a combination of the irradiation sections B7, B9, and B11 and a combination of the irradiation sections B8, B10, and B12, the light emitting operations of the corresponding light emitting sections 41 and the light receiving operations of the corresponding light receiving sections 51 are performed in parallel. Thus, in the ninth operation pattern 809, in a combination of the light emitting sections A1, A3, and A5 that are not adjacent to each other, a combination of the light emitting sections A2, A4, and A6, a combination of the light emitting sections A7, A9, and A11, and a combination of the light emitting sections A8, A10, and A12, the light emitting operations are performed at the same time u, and the light emitting periods overlap with each other. In the time u=5, the control unit 8 performs a read operation for each of the light receiving sections C1 to C12, thereby acquiring a result of the first light reception at the phase difference φ=0 degrees for all the irradiation sections 61. In the same manner, in the time u=6 to 10, a result of the second light reception at the phase difference φ=0 degrees is acquired, in the time u=11 to 15, a result of the first light reception at the phase difference q=180 degrees is acquired, and in the time u=16 to 20, a result of the second light reception at the phase difference φ=180 degrees is acquired. Thus, in the ninth operation pattern 809, the distance measurement of all the irradiation sections 61 (B1 to B12) is completed.

As illustrated in FIG. 16B, in the ninth operation pattern 809, a time until the distance measurement of all the irradiation sections 61 is completed is the unit time u×20 (=10.0 ms), and is smaller than the time (14.0 ms) in the eighth operation pattern 808. In addition, a time until the scheduled number of four light emitting periods in all the light emitting sections 41 are completed is the unit time u×19 (=9.5 ms), and is smaller than the time (13.5 ms) in the eighth operation pattern 808. Further, a distance measurement interval in the ninth operation pattern 809 is 4 times of unit time (2.0 ms).

That is, the distance measurement apparatus 1 operates according to the eighth operation pattern 808 or the ninth operation pattern 809 in which light emitting periods are allowed to be performed such that a light emitting period of a certain light emitting section Ai and a light emitting period in the light emitting section Ak (k≠i) that is not adjacent to the light emitting section Ai overlap with each other, the distance measurement interval is small as compared with a case of the operation according to an operation pattern (for example, the first operation pattern 801) in which the light emitting operation of the certain light emitting section Ai and a light emitting period of the light emitting section Aj (j≠i) do not overlap with each other. Accordingly, an influence of motion artifacts can be reduced.

In FIGS. 16A and 16B, in the eighth operation pattern 808 and the ninth operation pattern 809, the case where the predetermined cooling period H3 for reducing the influence of heat generation associated with light emission is 1.5 ms (3 times of unit time) is described, and the exemplary embodiment is not limited thereto.

In a case where light emitting operations are allowed to be performed such that a light emitting period in a certain light emitting section Ai and a light emitting period of a light emitting section Ak (k≠i) that is not adjacent to the light emitting section Ai overlap with each other, the distance measurement apparatus 1 according to the present exemplary embodiment operates according to a different operation pattern depending on a situation of a target object existing at the irradiation surface 60, an influence of heat generation of each light emitting section 41, and the like.

For example, as the amount of light emitted from the light emitting section 41 becomes larger, or as the cooling period of each light emitting section 41 required to reduce the influence of heat generation associated with light emission becomes larger, the distance measurement apparatus 1 operates according to an operation pattern in which the number of light emitting sections Ak (k≠i) that are not adjacent to the light emitting section Ai and have the light emitting periods overlapping with the light emitting period of the certain light emitting section Ai is small.

As described above, in the eighth operation pattern 808 in which the number of light emitting sections Ak (k≠i) that are not adjacent to the light emitting section Ai and have the light emitting periods overlapping with the light emitting period of the certain light emitting section Ai is small as compared with the ninth operation pattern 809, the distance measurement interval (3.0 ms) corresponding to the light non-emitting period is larger than the distance measurement interval (2.0 ms) of the ninth operation pattern 809. Accordingly, in the eighth operation pattern 808, a period that can be allocated as the cooling period of each light emitting section 41 is larger than a period in the ninth operation pattern 809.

Further, in the eighth operation pattern 808, the number of light emitting sections Ak (k≠i) that are not adjacent to the light emitting section Ai and have the light emitting periods overlapping with the light emitting period of the light emitting section Ai is small as compared with the ninth operation pattern 809, so that the amount of heat generated by all the light emitting units 4 per unit time in the eighth operation pattern 808 is smaller than the amount of heat in the ninth operation pattern 809.

The distance measurement apparatus 1 operates according to the eighth operation pattern 808, and thus the influence of heat generation such as a decrease in optical output of the VCSEL and a decrease in life is less likely to occur as compared with a case the operation according to the ninth operation pattern 809.

In addition, under a condition in which the influence of heat generated by each light emitting section 41 is unlikely to occur, the distance measurement apparatus 1 operates according to the ninth operation pattern 809 in which a large number of light emitting sections Ak (k≠i) that are not adjacent to the light emitting section Ai and have the light emitting periods overlapping with the light emitting period of the certain light emitting section Ai is large as compared with the eighth operation pattern 808. As described above, the distance measurement interval (2.0 ms) in the ninth operation pattern 809 is smaller than the distance measurement interval (3.0 ms) in the eighth operation pattern 808. Accordingly, the distance measurement apparatus 1 can reduce the influence of the motion artifacts, as compared with the case of the operation according to the eighth operation pattern 808.

Here, unlike the eighth operation pattern 808 and the ninth operation pattern 809 described above, the operation pattern of the distance measurement apparatus 1 can be set such that the light emitting period of the light emitting section Ai and the light emitting period of the adjacent light emitting section Aj (j≠i, k) overlap with each other. Meanwhile, in a case where the light emitting periods of the adjacent light emitting sections Ai and Aj overlap with each other, the periods during which the corresponding light receiving sections Ci and Cj perform the light receiving operations overlap with each other. As a result, for example, light emitted by the light emitting section Ai and reflected in the corresponding irradiation section Bi is incident not only onto the corresponding light receiving section Ci but also onto the adjacent light receiving section Cj, which may lead to a decrease in accuracy of the distance measurement in the light receiving section Cj. Therefore, for example, as in the eighth operation pattern 808 and the ninth operation pattern 809, the operation pattern of the distance measurement apparatus 1 may be set such that the light emitting period of the light emitting section Ai and the light emitting period of the non-adjacent light emitting section Ak are allowed to overlap with each other and the light emitting period of the light emitting section Ai and the light emitting period of the adjacent light emitting section Aj are not allowed to overlap with each other.

In the example of FIGS. 16A and 16B, the operation pattern is set such that the read operations of all the light receiving sections 51 (C1 to C12) are performed at the same time u, and the read operations may be performed on some or all of the light receiving sections 51 at the different times u.

### Cooling Period and Light Non-Emitting Period

In any of the first operation pattern 801 to the ninth operation pattern 809 described above, a case where the cooling period and the light non-emitting period are an integral multiple of the unit time is described as an example, and the cooling period and the light non-emitting period are not limited to the integral multiple of the unit time.

### Unit Time

In the example described above, the case where the operation pattern is set such that the light emitting period in which the light emitting section 41 performs the light emitting operation and the period in which the control unit 8 performs the read operation on the light receiving section 51 are equal to each other and a time (500 μs) corresponding to the light emitting period and the read operation period is used as the unit time is described. The light emitting period and the read operation period may be different from each other, and a time corresponding to either the larger one or the smaller one among the light emitting period and the read operation period can be set as the unit time. In a case where the larger one is selected, the larger light non-emitting period is secured, as compared with a case where the smaller one is set as the unit time. On the contrary, in a case where the smaller one is selected, the time until the scheduled number of light emitting periods in all the light emitting sections 41 are completed is smaller as completed with a case where the larger one is set as the unit time.

In addition, unlike the example described above, the operation pattern may be set without being based on the unit time.

### Scheduled Number of Times

In the example described above, the operation pattern is described by using a case where each light emitting section 41 has the scheduled number of four light emitting periods. The scheduled number of times is not limited. For example, in the indirect ToF method, in some cases, distance measurement is performed based on results of light reception twice at each of four phase differences φ of 0 degrees, 90 degrees, 180 degrees, and 270 degrees with respect to light emission. Thus, in a case of performing distance measurement of, for example, a certain irradiation section Bi in the distance measurement apparatus 1, a light emitting operation in the corresponding light emitting section Ai, a light receiving operation at the phase difference φ in the corresponding light receiving section Ci, and a read operation for the light receiving section Ci by the control unit 8 are respectively repeated eight times. More specifically, the eight light emitting operations are performed in each light emitting section 41, the eight light receiving operations are performed in each light receiving section 51, and the eight read operations are performed on each light receiving section 51.

### Distance Measurement Apparatus 1, Light Emitting Apparatus 2, and Drive Device 10

The distance measurement apparatus 1 that operates according to the first operation pattern 801 to the ninth operation pattern 809 described above is an example of a distance measurement apparatus including a drive unit that drives a light emitting unit such that each light emitting section has a predetermined plurality of light emitting periods and a light non-emitting period following each light emitting period, and can switch a second light emitting section other than a first light emitting section, which has a light emitting period to be included in a light non-emitting period of the first light emitting section among a plurality of light emitting sections.

Further, as illustrated by a broken line in FIG. 1, a light emitting apparatus 2 can be configured with the light emitting unit 4, the light emission drive unit 6, and the control unit 8. In other words, the light emitting apparatus 2 can be configured to cause the light emitting unit 4 to emit light according to the first operation pattern 801 to the ninth operation pattern 809. This light emitting apparatus 2 is an example of a light emitting apparatus including a drive unit that drives a light emitting unit such that each light emitting section has a predetermined plurality of light emitting periods and a light non-emitting period following each light emitting period, and can switch a second light emitting section other than a first light emitting section, which has a light emitting period to be included in a light non-emitting period of the first light emitting section among a plurality of light emitting sections.

Further, as illustrated by the one-dot chain line in FIG. 1, a drive device 10 can be configured with the light emission drive unit 6 and the control unit 8 to drive the light emitting unit 4 (an example of a light emitting device). In other words, the drive device 10 can be configured to drive the light emitting unit 4 such that the light emitting unit 4 emits light according to the first operation pattern 801 to the ninth operation pattern 809. The drive device 10 is an example of a drive device that drives a light emitting unit such that each light emitting section has a predetermined plurality of light emitting periods and a light non-emitting period following each light emitting period, and can switch a second light emitting section other than a first light emitting section, which has a light emitting period to be included in a light non-emitting period of the first light emitting section among a plurality of light emitting sections.

### Supplementary Notes

(((1)))

A drive device configured to:
cause a light emitting device including a plurality of light emitting sections to emit light such that each of the light emitting sections has a predetermined plurality of light emitting periods and a light non-emitting period following each of the light emitting periods; and
switch a second light emitting section other than a first light emitting section among the plurality of light emitting sections, which has a light emitting period to be included in a light non-emitting period of the first light emitting section.
(((2)))

The drive device according to (((1))),
wherein the number of second light emitting sections or a position of the second light emitting section with respect to the first light emitting section is switched according to a target object irradiated with the light by the light emitting device.
(((3)))

The drive device according to (((2))),
wherein in a case where the target object moves, the number of second light emitting sections is set to be decreased as a movement speed of the target object is increased.
(((4)))

The drive device according to (((2))) or (((3))),
wherein in a case where the target object moves in a first direction, among the plurality of light emitting sections, the light emitting section arranged in the first direction with respect to the first light emitting section is set as the second light emitting section.
(((5)))

The drive device according to any one of (((1))) to (((4))),
wherein the number of second light emitting sections is set to be increased as the amount of light emitted from the plurality of light emitting sections of the light emitting device is increased.
(((6)))

The drive device according to (((1))),
wherein the light emitting device is driven such that after the plurality of light emitting periods of one light emitting section group among a plurality of light emitting section groups each including the first light emitting section and the second light emitting section having the light emitting period to be included in the light non-emitting period of the first light emitting section, the plurality of light emitting periods of a next light emitting section group are started, and
the number of second light emitting sections or a position of the second light emitting section with respect to the first light emitting section differs for each of the light emitting section groups.
(((7)))

The drive device according to (((6))),
wherein the number of second light emitting sections or the position of the second light emitting section with respect to the first light emitting section differs between one light emitting section group including the light emitting section that irradiates a target object with the light, and another light emitting section group that does not irradiate the target object with the light.
(((8)))

The drive device according to any one of (((1))) to (7))),
wherein among the plurality of light emitting sections, a third light emitting section that is different from the first light emitting section and the second light emitting section and is not adjacent to the first light emitting section emits light such that a light emitting period of the third light emitting section overlaps with the light emitting period of the first light emitting section.
(((9)))

A light emitting apparatus comprising:
a light emitting unit that includes a plurality of light emitting sections; and
a drive unit configured to drive the light emitting unit such that each of the light emitting sections has a predetermined plurality of light emitting periods and a light non-emitting period following each of the light emitting periods, and switch a second light emitting section other than a first light emitting section among the plurality of light emitting sections, which has a light emitting period to be included in a light non-emitting period of the first light emitting section.
(((10)))

A distance measurement apparatus comprising:
a light emitting unit that includes a plurality of light emitting sections;
a drive unit configured to drive the light emitting unit such that each of the light emitting sections has a predetermined plurality of light emitting periods and a light non-emitting period following each of the light emitting periods, and switch a second light emitting section other than a first light emitting section among the plurality of light emitting sections, which has a light emitting period to be included in a light non-emitting period of the first light emitting section;
a light receiving unit that receives light emitted from the light emitting unit and reflected by a target object; and
a control unit that calculates a distance to the target object based on a result of light reception by the light receiving unit.
(((11)

The distance measurement apparatus according to (((10))),
wherein the drive unit acquires an index that is changed due to heat generation of the plurality of light emitting sections of the light emitting unit, and
the second light emitting section is switched according to the index in a case where the plurality of light emitting sections of the light emitting unit emit light under a predetermined condition.
(((12)))

The distance measurement apparatus according to (((11))),
wherein the drive unit switches the second light emitting section according to a result of the light reception by the light receiving unit as the index in a case where the plurality of light emitting sections of the light emitting unit emit light under a predetermined condition.
(((13))

The distance measurement apparatus according to (((10))), further comprising:
an imaging unit that captures an image of the target object irradiated with the light by the light emitting unit,
wherein the drive unit switches the second light emitting section according to a situation of the target object ascertained from the image captured by the imaging unit.
(((14)))

The distance measurement apparatus according to any one of (((10))) to (((13))),
wherein after the first light emitting section and the second light emitting section complete a light emitting period once, the control unit acquires a result of the light reception received by the light receiving unit from a start of the light emitting period of the first light emitting section to an end of the light emitting period of the second light emitting section, and
the drive unit switches the number of second light emitting sections such that a sum of an acquisition period required for the control unit to acquire the result of the light reception and the light emitting period of the second light emitting section included in the light non-emitting period of the first light emitting section does not fall below a predetermined cooling period required for cooling each of the light emitting sections.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A drive device configured to:
cause a light emitting device including a plurality of light emitting sections to emit light such that each of the light emitting sections has a predetermined plurality of light emitting periods and a light non-emitting period following each of the light emitting periods; and
switch a second light emitting section other than a first light emitting section among the plurality of light emitting sections, which has a light emitting period to be included in a light non-emitting period of the first light emitting section.

2. The drive device according to claim 1,
wherein the number of second light emitting sections or a position of the second light emitting section with respect to the first light emitting section is switched according to a target object irradiated with the light by the light emitting device.

3. The drive device according to claim 2,
wherein in a case where the target object moves, the number of second light emitting sections is set to be decreased as a movement speed of the target object is increased.

4. The drive device according to claim 2,
wherein in a case where the target object moves in a first direction, among the plurality of light emitting sections, the light emitting section arranged in the first direction with respect to the first light emitting section is set as the second light emitting section.

5. The drive device according to claim 3,
wherein in a case where the target object moves in a first direction, among the plurality of light emitting sections, the light emitting section arranged in the first direction with respect to the first light emitting section is set as the second light emitting section.

6. The drive device according to claim 1,
wherein the number of second light emitting sections is set to be increased as the amount of light emitted from the plurality of light emitting sections of the light emitting device is increased.

7. The drive device according to claim 1,
wherein the light emitting device is driven such that after the plurality of light emitting periods of one light emitting section group among a plurality of light emitting section groups each including the first light emitting section and the second light emitting section having the light emitting period to be included in the light non-emitting period of the first light emitting section, the plurality of light emitting periods of a next light emitting section group are started, and
the number of second light emitting sections or a position of the second light emitting section with respect to the first light emitting section differs for each of the light emitting section groups.

8. The drive device according to claim 7,
wherein the number of second light emitting sections or the position of the second light emitting section with respect to the first light emitting section differs between one light emitting section group including the light emitting section that irradiates a target object with the light, and another light emitting section group that does not irradiate the target object with the light.

9. The drive device according to claim 1,
wherein among the plurality of light emitting sections, a third light emitting section that is different from the first light emitting section and the second light emitting section and is not adjacent to the first light emitting section emits light such that a light emitting period of the third light emitting section overlaps with the light emitting period of the first light emitting section.

10. A light emitting apparatus comprising:
a light emitting unit that includes a plurality of light emitting sections; and
a drive unit configured to drive the light emitting unit such that each of the light emitting sections has a predetermined plurality of light emitting periods and a light non-emitting period following each of the light emitting periods, and switch a second light emitting section other than a first light emitting section among the plurality of light emitting sections, which has a light emitting period to be included in a light non-emitting period of the first light emitting section.

11. A distance measurement apparatus comprising:
a light emitting unit that includes a plurality of light emitting sections;
a drive unit configured to drive the light emitting unit such that each of the light emitting sections has a predetermined plurality of light emitting periods and a light non-emitting period following each of the light emitting periods, and switch a second light emitting section other than a first light emitting section among the plurality of light emitting sections, which has a light emitting period to be included in a light non-emitting period of the first light emitting section;
a light receiving unit that receives light emitted from the light emitting unit and reflected by a target object; and
a control unit that calculates a distance to the target object based on a result of light reception by the light receiving unit.

12. The distance measurement apparatus according to claim 11,
wherein the drive unit acquires an index that is changed due to heat generation of the plurality of light emitting sections of the light emitting unit, and
the second light emitting section is switched according to the index in a case where the plurality of light emitting sections of the light emitting unit emit light under a predetermined condition.

13. The distance measurement apparatus according to claim 12,
wherein the drive unit switches the second light emitting section according to a result of the light reception by the light receiving unit as the index in a case where the plurality of light emitting sections of the light emitting unit emit light under a predetermined condition.

14. The distance measurement apparatus according to claim 11, further comprising:
an imaging unit that captures an image of the target object irradiated with the light by the light emitting unit,
wherein the drive unit switches the second light emitting section according to a situation of the target object ascertained from the image captured by the imaging unit.

15. The distance measurement apparatus according to claim 11,
wherein after the first light emitting section and the second light emitting section complete a light emitting period once, the control unit acquires a result of the light reception received by the light receiving unit from a start of the light emitting period of the first light emitting section to an end of the light emitting period of the second light emitting section, and
the drive unit switches the number of second light emitting sections such that a sum of an acquisition period required for the control unit to acquire the result of the light reception and the light emitting period of the second light emitting section included in the light non-emitting period of the first light emitting section does not fall below a predetermined cooling period required for cooling each of the light emitting sections.
